(19) United States
(12) Patent Application Publication
(10) Pub. No.: US 2013/0135811 A1
(43) Pub. Date: May 30, 2013

(54) Architecture For A Robust Computing System

(71) Applicants: John Craig Dunwoody, Belmont, CA (US); Teresa Ann Dunwoody, Belmont, CA (US)

(72) Inventors: John Craig Dunwoody, Belmont, CA (US); Teresa Ann Dunwoody, Belmont, CA (US)

(73) Assignee: Birchbridge Incorporated, Belmont, CA (US)

(21) Appl. No.: 13/811,649

(22) PCT Filed: Jul. 21, 2011
(86) PCT No.: PCT/US11/44809

§ 371 Date: Jan. 22, 2013

(30) Foreign Application Priority Data
Jul. 21, 2010 (US) 12840788
Jul. 21, 2010 (US) 12840808
Jul. 21, 2010 (US) 12840824
Jul. 21, 2010 (US) 12840857
Jul. 21, 2010 (US) 12840842
Jul. 21, 2010 (US) 12840871

(51) Int. Cl. F28F 9/00; G06F 1/18

(52) U.S. Cl. CPC F28F 9/00; G06F 1/189
USPC 361/679.31; 165/67

(57) ABSTRACT

Example rack systems that support computing platforms and related hardware are provided. Multiple instances of the example rack system may be combined to create scalable systems. The example racks may incorporate a universal backplane upon which one or more backplane boards may be mounted. Modules of varied functions may be inserted into the backplane boards via a module insertion area. The example racks may include a power bus for powering the backplane boards. The rack system may also include thermal plates, coolant transmission, and cable management solutions to promote heat dissipation. Related apparatuses and methods are also provided.

### FIELD

This application relates to various architectures for rack mounted data networking, processing, and storage systems.

### BACKGROUND

Current standard computer rack configurations are measured in vertical rack-units (RUs). For example, a server computer may have a rack-mountable chassis measuring 19 inches wide and 1.75 inches (1 RU) high. A common computer rack size is 42 RU. Higher density component systems are desirable because they require less space per rack enclosure, and ultimately less space within the building housing the enclosures. Often these buildings must include raised floors to accommodate network cabling and the delivery of chilled air and power to the enclosures. A key factor in determining component density is the size of the vertical rack unit, as often limited by the space required for component heat sinks and associated cooling components (e.g., fans).

Conventional computer rack systems offer great flexibility and modularity in configuring hardware to provide data networking, processing, and storage capacity, but they are relatively inefficient in terms of capacity per unit of space, operational energy use, and purchase and maintenance costs. A variety of available “blade” systems can offer higher efficiency, but they are less flexible. As such, there is a need for a unit with superior efficiency in data networking, processing, and storage, while preserving flexibility.

Of particular concern is the cooling of the rack's components. During operation, the electrical components produce heat, which a system must displace to ensure the proper functioning of its components. In addition to maintaining normative function, advanced cooling methods, such as liquid cooling, can be used to either achieve greater processor performance (e.g., overclocking), or to reduce the noise pollution caused by typical cooling methods (e.g., cooling fans and heat sinks). A frequently underestimated problem when designing high-performance computer systems is matching the amount of heat a system generates, particularly in high performance and high density enclosures, to the ability of its cooling system to remove the heat uniformly throughout the rack enclosure.

In many applications where a large amount of processing power and other computing resources are required, a plurality of the racks may be ganged (or chained) together to provide increased capacity. As the ability to cool components and the ability to create racks with a high density of functional modules increases, massive processing capacity can be achieved by interconnecting such racks.

Other factors may also impact heat removal efficiency. For example, bundles of excess cabling may be stuffed into void spaces and limit heat removal from such spaces. Thus, it may be advantageous to provide a mechanism that improves management of excess cable within a rack enclosure.

Additionally, due to the power requirements and heat removal requirements that often accompany standard servers, server banks are typically connected to fixed power and cooling sources and are therefore immobile. However, certain use cases may require significant networking, processing, and storage capabilities to be mobile.

### SUMMARY

In one embodiment, a computer system is provided. The computer system may include one or more rack unit switches and one or more rack unit cluster nodes. Each rack unit switch may include one or more switch units, each with a plurality of ports. Each rack unit cluster node may include one or more cluster units, each with a plurality of processing units and a cluster switch with a plurality of ports. The ports of the rack unit switches may be coupled to the ports of the rack unit cluster nodes, to create a network architecture. An example system configuration with a total of 10,368 processing units may include four rack unit switches, each containing four 648-port switch units, and 24 rack unit cluster nodes, each containing 27 cluster units. Each example cluster unit may contain 16 processing units and a 36-port cluster switch, with 16 ports connected to the processing units, and 16 cable ports, one connected via cable to each of the total of 16 648-port switch units in the system.

In one embodiment, a rack system includes a cooled universal hardware platform having a frame, a module insertion area on a first side of the rack system, a universal backplane mounting area on a second side of the rack system opposite to the first side, a power bus, a plurality of cooled partitions, a plurality of module bays, two or more service unit backplanes, and a coolant source.

The power bus may be configured to provide power to the universal backplane mounting area, and the plurality of cooled partitions, in one embodiment, may be coupled within the frame perpendicular to the first side of the rack. A module bay of the plurality of module bays may be defined by a volume of space between adjacent cooled partitions of the plurality of cooled partitions. In one embodiment, each module bay has a pitch (P) equal to the distance from the first surface of one cooled partition to the second surface of an adjacent cooled partition.

In one embodiment, the two or more service unit backplanes are coupled to the universal backplane mounting area and to the power bus. Each service unit backplane may include one or more connectors configured to connect to modules of the corresponding two or more service units. In various embodiments, each service unit may be configured individually to have specific functions within the rack system.

In one embodiment, a coolant source is coupled to the plurality of cooled partitions, wherein each cooled partition may include capillaries between a first surface and a second surface of each cooled partition to permit coolant flow within, and provide cooling to the two or more service units.

In one embodiment, the universal backplane mounting area may include a plurality of backplane board mounts, wherein a vertical distance between any two mounts is configured to conform to a multiple of a standard unit of height. The board mounts may be holes configured to be used in conjunction with a fastener and a service unit backplane configured to conform to a multiple of the standard unit of height. In another embodiment, the board mounts may be protruding elements configured to be used in conjunction with a fastener and a service unit backplane configured to conform to a multiple of the standard unit of height. Additionally, according to one embodiment, the pitch (P) may correspond with the standard unit of height, which may be, for example, 0.75 inches.

In one embodiment, the platform includes a rack power unit coupled within the frame and comprising one or more rack power modules to convert alternating current (AC) to direct current (DC). The power bus may be coupled to the one or more rack power modules to deliver DC to the one or more service unit backplanes. The rack power unit may be configured to convert 480 volt three-phase AC to 380 volt DC and provide it to the power bus. In one embodiment, each of the one or more rack power modules is configured to convert the 480 volt three-phase AC to 380 volt DC. In another embodiment, the power bus is coupled to a 380 volt DC source external to the frame.

In one embodiment, each cooled partition of the plurality of cooled partitions includes a first coolant distribution node located at a first edge of the cooled partition and coupled to the coolant source by a first coolant pipe, wherein the first coolant distribution node is configured to distribute coolant uniformly within the cooled partition. Each cooled partition may also include a second coolant distribution node located at a second edge of the cooled partition and configured to receive coolant after it passes from the first coolant distribution node and through the cooled partition, the second coolant distribution node coupled to a second coolant pipe leading out of the universal hardware platform.

In one embodiment, each of the first coolant distribution nodes of each cooled partition is coupled to the coolant source by the first coolant pipe, and each of the second coolant distribution nodes of each cooled partition is coupled to the coolant source by the second coolant pipe.

In one embodiment, each service unit includes at least one component module inserted into at least one of the plurality of module bays.

In one embodiment, each component module includes a first thermal plate substantially parallel to a second thermal plate, wherein each thermal plate includes an inner-facing surface, and an outer-facing surface opposite to the inner-facing surface. Each thermal plate may be configured to physically and thermally couple its inner-facing surface to one or more component units.

In one embodiment, each component module includes one or more tensioning units, coupled to and locatable between the first and the second thermal plate. The one or more tensioning units may be configured to provide a contact bias between the outer surface of each thermal plate and each surface of the cooled partitions comprising a module bay, when the component module is inserted into the module bay. Each component unit may include at least one connector configured to connect into a service unit backplane, and the at least one connector may be configured to overlap at least one of the first thermal plate and the second thermal plate when inserted into one of the plurality of module bays.

In one embodiment, a minimum pitch (P) of a module bay is determined by the distance between the first thermal plate and the second thermal plate and the at least one overlapping connector.

In one embodiment, a cable slack management system is provided. The slack management system may include a frame and a cable management module. The frame may include a plurality of perimeter frame members to provide support for a plurality of component modules. The plurality of component modules may be locatable between a first frame member and a second frame member parallel to the first frame member. The cable management module may be coupled to the first frame member and configured to slide into and out of the first frame member. The cable management module may be configured to hold a portion of one or more cables that run along the first frame member.

In another exemplary embodiment, a cable management system for a rack mounted network platform is provided. The cable management system may include a rack frame, a plurality of shelves, one or more modules, and one or more cable management modules. The rack frame may include a plurality of perimeter frame members to provide support for a plurality of component modules insertable through a module insertion area on a first side of the rack frame having a first frame member and a second frame member parallel to the first frame member. The plurality of shelves may be coupled to the perimeter frame members within the rack frame. Each shelf may have a first surface and a second surface. The plurality of shelves may be substantially parallel to each other, and substantially perpendicular to the plane of the first side of the rack. The one or more modules may be inserted through the module insertion area between the first frame member and the second frame member. At least one of the one or more modules is in operable communication with one or more cables. The one or more cable management modules may be coupled to at least one of the first frame member and the second frame member. Each cable management module is configured to slide into and out of a corresponding one of the first frame member or the second frame member. The cable management module is configured to hold a portion of the one or more cables configured to run along the corresponding one of the first frame member or the second frame member.

In an example embodiment, a module for insertion between a first shelf and a second shelf of a rack based processing system is provided. The module includes a first thermal plate substantially parallel to a second thermal plate. An inner surface of the first thermal plate faces an inner surface of the second plate, and an outer surface of each of the first and second thermal plates faces opposite to the respective inner surfaces. Each thermal plate is configured to thermally couple to one or more component units locatable between the inner surfaces of the first and second thermal plates.

In another example embodiment, a conduction cooling apparatus for a rack based processing system is provided. The apparatus includes a frame, a plurality of shelves, a plurality of bays, and a module unit. The frame includes a module insertion area on a first side of the rack. The plurality of shelves are positioned within the frame and coupled to a coolant source. Each shelf has a first surface and a second surface, and is configured to permit coolant flow between the first and second surfaces. Among the plurality of shelves, each is positioned substantially parallel to the others, and substantially perpendicular to a plane of the first side of the rack. In the plurality of bays, each bay may be defined by a volume of space between adjacent ones of the plurality of shelves. The module unit may be configured to be inserted into a bay of the plurality of bays. The module unit includes a first thermal plate substantially parallel to a second thermal plate. An inner surface of the first thermal plate faces an inner surface of the second plate, and an outer surface of each of the first and second thermal plates faces opposite to the respective inner surfaces. Each thermal plate is configured to thermally couple to one or more component units locatable between the inner surfaces of each thermal plate.

In another exemplary embodiment, a method of cooling one or more component units in a frame of a rack based processing system is provided. The method includes providing coolant to a plurality of shelves coupled within the frame and cooling the one or more component units coupled to a module unit inserted between a first shelf and a second shelf. Each shelf includes a first surface and a second surface having coolant flowing therebetween. Each module unit includes a first plate substantially parallel to a second plate. Each module also includes one or more component units locatable between the first and second plates, providing a thermal coupling of the one or more component units to at least one of the first shelf and the second shelf.

In an exemplary embodiment, a rack frame is provided. The rack frame may include a module insertion area, a universal backplane area, and a power bus. The module insertion area may be provided on a first side of the rack frame. The universal backplane area may be provided on a second side of the rack frame opposite to the first side. The universal backplane area may include at least one mounting surface configured to mount two or more backplane boards. In some cases, at least two of the backplane boards are configured to couple to two respective modules, each having at least two different functions and insertable through the module insertion area. The at least two different functions of at least one backplane board may include rack power and management functions. The power bus may provide power to the two or more backplane boards mounted in the universal backplane area.

In another exemplary embodiment, a universal backplane is provided. The universal backplane may include a first backplane board and a second backplane board. Each backplane board may include a plurality of connector receptacles, in which each connector receptacle is configured to receive backplane connectors from respective ones of a plurality of modules that are mountable in a same side of a rack to which the first and second backplane boards are connectable. At least one of the first backplane board or the second backplane board may include a fixed function backplane board for power and management control functions of the modules insertable into the rack.

Embodiments of the present invention may provide an efficient way to cool and power components housed in a rack system. Thus, not only may more components be cooled for relatively less cost and with relatively less complexity, but very robust data networking, processing, and storage capabilities may be provided in relatively smaller spaces. These advances may enable some embodiments to have significant capabilities in a mobile environment.

In an exemplary embodiment, a mobile processing system is provided. The mobile processing system may include a mobile container. The mobile container may include a bottom element, a top element, a front element, a back element, and two side elements defining a containment volume. The two side elements may have a length longer than a length of either the front element or the back element. The containment volume may be configured to include a plurality of rack frames. Each rack frame may include a module insertion area on a first side of the rack frame, a universal backplane area, and a power bus. The universal backplane area may be positioned on a second side of the rack frame opposite to the first side, and may include at least one mounting surface configured to mount two or more backplane boards. At least two of the backplane boards may be configured to couple to two respective modules that each have at least two different functions and are insertable through the module insertion area. The at least two different functions of at least one backplane board may include rack power and management functions. The power bus may provide power to the two or more backplane boards mounted in the universal backplane area.

In another exemplary embodiment, a mobile container is provided. The mobile container may include a bottom element, a top element, a front element, a back element, and two side elements defining a containment volume. The two side elements may have a length longer than a length of either the front element or the back element. The containment volume may be configured to include a plurality of rack frames. Each rack frame may include a module insertion area on a first side of the rack frame, a universal backplane area, and a power bus. The universal backplane area may be positioned on a second side of the rack frame opposite to the first side, and may include at least one mounting surface configured to mount two or more backplane boards. At least two of the backplane boards may be configured to couple to two respective modules that each have at least two different functions and are insertable through the module insertion area. The at least two different functions of at least one backplane board may include rack power and management functions. The power bus may provide power to the two or more backplane boards mounted in the universal backplane area.

### BRIEF DESCRIPTION OF THE DRAWINGS

The present invention is illustrated by way of example, and not by way of limitation, in the figures of the accompanying drawings in which:

FIG. 1 illustrates an embodiment of a rack system including a cooled universal hardware platform;

FIG. 2 illustrates a portion of the side of the rack system and the cooled universal hardware platform, according to one embodiment;

FIG. 3 illustrates an example embodiment of a rack system, and specifically the rear portion and the open side of the rack, and the cooled universal hardware platform;

FIG. 4 illustrates a block diagram of a cluster switch, according to an exemplary embodiment;

FIG. 5 illustrates a block diagram of a gateway module, according to an exemplary embodiment;

FIG. 6 illustrates a block diagram of a processing module, according to an exemplary embodiment;

FIG. 7 illustrates a block diagram of a rack management module according to an exemplary embodiment;

FIG. 8 illustrates a block diagram of a rack power module according to an exemplary embodiment;

FIG. 9 illustrates an embodiment of a cooled partition found within the rack system;

FIG. 10 illustrates an embodiment of several cooled partitions making up the module bays as viewed outside of the rack system;

FIGS. 11 and 12 illustrate embodiments of a module fixture that includes circuit boards and components that make up a functional module in a service unit;

FIGS. 13 and 14 illustrate embodiments of the module fixture from a side view in an uncompressed and compressed state, respectively;

FIGS. 15 and 16 illustrate embodiments of a module fixture for a rack power board insertable into the rack power section of the rack system;

FIG. 17 illustrates an arrangement of a plurality of rack units, to provide interconnection thereof for a robust computing environment according to an exemplary embodiment;

FIG. 18 illustrates an example architecture of a switch unit according to an example embodiment;

FIG. 19 illustrates an exemplary topology of the switch unit according to an example embodiment;

FIG. 20 illustrates an exemplary topology for connection of twenty-four rack unit cluster nodes via four rack unit switches, according to an example embodiment;

FIG. 21 illustrates an example embodiment employing a cable slack management system;

FIG. 22 shows a top view of a cable drawer, according to one example embodiment;

FIG. 23 shows a side view of the cable drawer with transparent side members to permit viewing of the contents of the cable drawer, for ease of explanation according to an example embodiment;

FIG. 24 shows a top view of the cable drawer, according to this example embodiment;

FIG. 25 shows a side view of the cable drawer with transparent side members to permit viewing of the contents of the cable drawer, for ease of explanation according to an example embodiment;

FIG. 26, which includes FIGS. 26A and 26B, shows an example of a thermal plate that includes a frame and a heat exchanger insert, according to an exemplary embodiment;

FIG. 27, which includes FIGS. 27A and 27B, shows an example of a thermal plate having a frame including multiple insert receptacles for supporting a corresponding number of heat exchanger inserts, according to an exemplary embodiment;

FIG. 28 illustrates an example of using airflow for cooling, according to an exemplary embodiment;

FIG. 29 illustrates a perspective view of a mobile container, according to an exemplary embodiment;

FIG. 30 illustrates a plan view of a mobile container with rack systems installed therein, according to an exemplary embodiment;

FIG. 31 illustrates a perspective view of a mobile container with rack systems provided therein, according to an exemplary embodiment; and

FIG. 32 illustrates an alternative plan view of a mobile container with rack systems installed therein, according to an exemplary embodiment.

### DETAILED DESCRIPTION

Although embodiments of the present invention have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Embodiments of the present invention generally relate to an architecture for a scalable modular data system. In this regard, embodiments of the present invention relate to a rack system (e.g., rack system 10) that may contain a plurality of service units or modules. The rack system described herein provides physical support, power, and cooling for the service units or modules contained therein. The rack system also provides a set of interfaces for the service units or modules based on, for example, mechanical, thermal, electrical, and communication protocol specifications. Moreover, the rack system described herein may be easily networked with a plurality of instances of other rack systems to create a highly scalable modular architecture.

Each service unit or module that may be housed in the rack system provides some combination of data networking, processing, and storage capacity, enabling the service units to provide functional support for various computing, data processing, and storage activities (e.g., as processing units, storage arrays, network switches, etc.). However, some embodiments of the present invention provide a mechanical structure for the rack system and the service units or modules that also provides for efficient heat removal from the service units or modules in a compact design. Thus, the amount of data networking, processing, and storage capacity that can be provided for given amounts of energy consumption, space, manufacturing cost, and lifecycle maintenance cost, may be increased.

In addition to the efficient removal of heat to provide for an ability to concentrate more data networking, processing, and storage capacity in a smaller area, some embodiments of the present invention may also provide for improved rack cable management. In this regard, excess cable may be stored in an efficient and organized fashion. Thus, rather than simply bundling excess cable together and stuffing the bundle into a void within the rack system, which may impede access to portions of the service units or modules and also hinder heat removal efficiency, the excess cable may be accounted for in a manner that enhances accessibility of the excess cable while providing for storage of the excess cable in a manner that does not negatively impact the rack system. Thus, exemplary rack systems are described, with, for example, a cable management system.

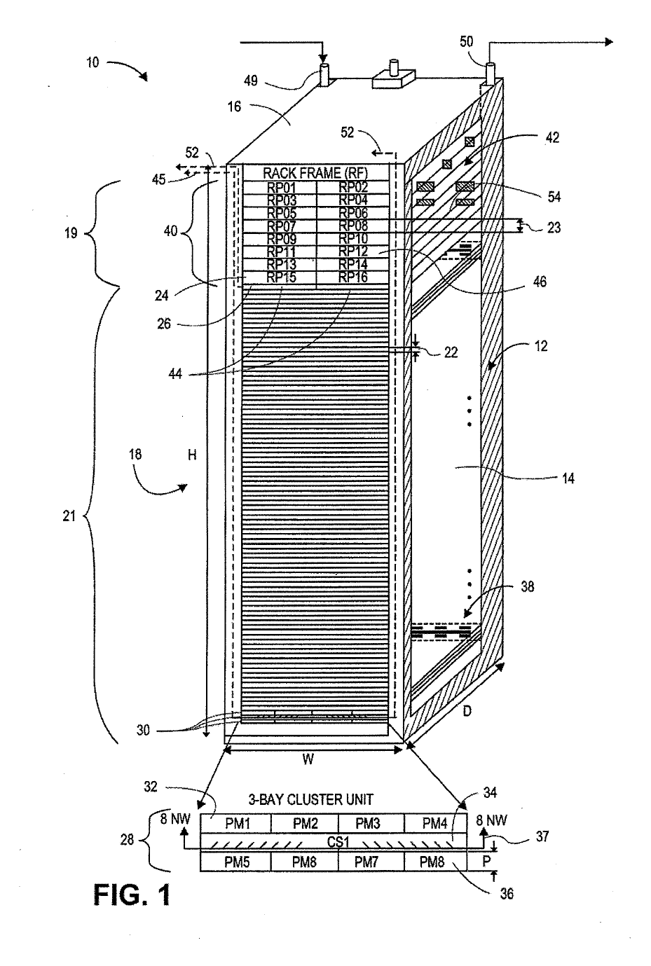

FIG. 1 illustrates an embodiment of a rack system 10. Rack system 10 includes a rack power section 19 and a universal hardware platform 21. The universal hardware platform 21 includes a universal backplane mounting area 14. The rack system 10 has a perimeter frame 12 having a height ‘H’, width ‘W’, and depth ‘D.’ In one embodiment, the perimeter frame 12 includes structural members around the perimeter of the rack system 10 and is otherwise open on each vertical face. In other embodiments, some or all of the rack's faces or planes may be enclosed, as illustrated by rack top 16.

The front side of the rack, rack front 18, may include a multitude of cooled partitions substantially parallel to each other and at various pitches, such as pitch 22 (P), where the pitch may be equal to the distance from the first surface of one cooled partition to the second surface of an adjacent cooled partition. The area or volume between the adjacent partitions defines a module bay, such as module bay 24 or module bay 26. The module bays may have different sizes based on their respective pitches, such as pitch 22 corresponding to module bay 26 and pitch 23 corresponding to module bay 24. It can be appreciated that the pitch may be determined any number of ways, such as between the mid-lines of each partition, or between the inner surfaces of two consecutive partitions. In one embodiment, the pitch 22 is a standard unit of height, such as 0.75 inches, and variations of the pitch, such as pitch 23, may be a multiple of the pitch 22. For example, pitch 23 is two times the pitch 22, where pitch 22 is the minimum pitch based on module or other design constraints.

The rack system 10, and specifically the universal hardware platform 21, may be configured to include a multitude of service units. Each service unit may provide a combination of data processing capacity, data storage capacity, and data communication capacity. In one embodiment, the rack system 10 provides physical support, power, and cooling for each service unit that it contains. A service unit and its corresponding service unit backplane correspond to a rack unit model. The rack unit model defines a set of interfaces for the service unit, which may be provided in accordance with mechanical, thermal, electrical, and communication-protocol specifications. Thus, any service unit that conforms to the interfaces defined by a particular rack unit model may be installed and operated in a rack system that includes the corresponding service unit backplane. For example, the service unit backplane mounts vertically to the universal backplane mounting area 14 and provides the connections according to the rack unit model for all of the modules that perform the functions of the service unit.

Cluster unit 28 is an example of a service unit configured with a network switch and sixteen processing units. In this embodiment, the cluster unit 28 spans over three module bays, module bays 30, and includes eight processing modules and a cluster switch. Specifically, the cluster unit 28 includes the four processing modules 32 (PM1-PM4) in the first module bay, a cluster switch 34 (CS1) in the second module bay, and the remaining processing modules 36 (PM5-PM8) in the third module bay.

Each of these modules may slide into its respective slot within the module bay and connect into a service unit backplane, such as cluster unit backplane 38. The cluster unit backplane 38 may be fastened to the perimeter frame 12 in the universal backplane mounting area 14. The combination of the cluster switch 34 and the cluster unit backplane 38 in this embodiment has the advantage of signal symmetry, where the signal paths of the processing modules 32 and 36 are equidistant to the cluster switch 34.

In one embodiment, the cluster switch 34 has eight network lines exiting out of the front of the cluster switch 34 toward each side of the rack front 18; see for example network lines 37. For simplicity, only one cluster switch (e.g., cluster switch 34) is shown; however, it can be appreciated that a multitude of cluster switches may be included in the rack system 10. Thus, the cables or network lines for every installed cluster switch may run up the perimeter frame 12 and exit the rack top 16 in a bundle, as illustrated by net 52.

In various embodiments, some or all of the service units, such as the cluster unit 28 including the processing modules 32 and the cluster switch 34, are an upward-compatible enhancement of mainstream industry-standard high performance computing (HPC)-cluster architecture, with x86_{—}64 instruction set architecture (ISA) and standard Ethernet or InfiniBand networking interconnects. This enables one hundred percent compatibility with existing system and application software used in mainstream HPC cluster systems, and is immediately useful to end-users upon product introduction, without extensive software development or porting. Thus, implementation of these embodiments includes using commercial off the shelf (COTS) hardware and firmware whenever possible, and does not include any chip development or require the development of complex system and application software. As a result, these embodiments dramatically reduce the complexity and risk of the development effort, improve energy and cost efficiency, and provide a platform to enable application development for concurrency between simulation and visualization computing to thereby reduce data-movement bottlenecks. The efficiency of the architecture of the embodiments applies equally to all classes of scalable computing facilities, including traditional enterprise-datacenter server farms, cloud/utility computing installations, and HPC clusters. This broad applicability maximizes the opportunity for significant improvements in energy and environmental efficiency of computing infrastructures. It should be noted that custom circuit and chip designs could also be used in the disclosed rack system design, but these would not likely be as cost effective as using COTS components.

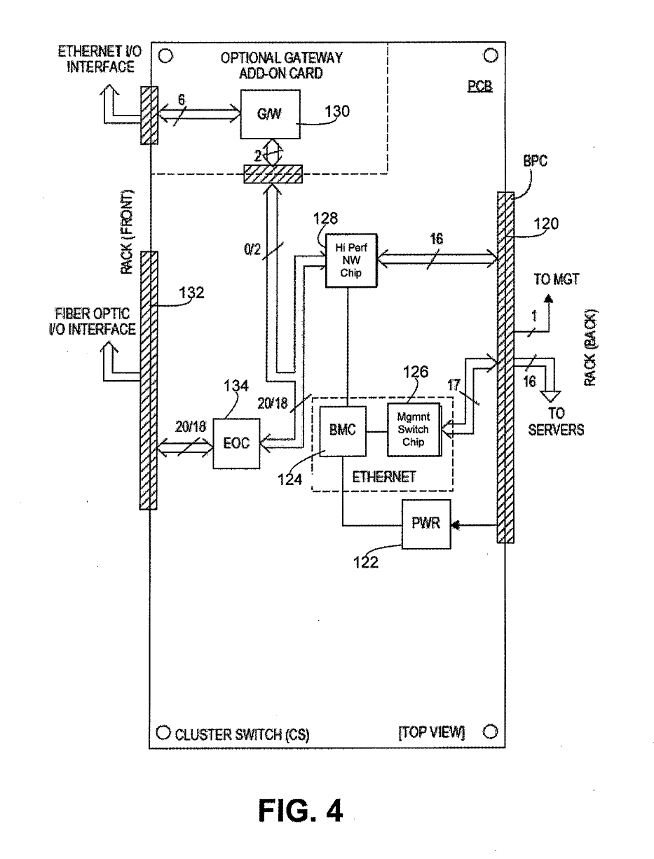

A diagram showing a cluster switch according to an example embodiment is provided in FIG. 4. In this regard, the cluster switch may include a backplane connector (BPC) 120 that may connect the cluster switch 34 to the cluster unit backplane 38. In some embodiments, the BPC 120 may include at least sixteen management ports to connect to downstream processing modules, and one management port for a connection to an upstream management module. A power module 122 may be coupled to the BPC 120 to bring in power from the cluster backplane 38. The power module 122 may be in communication with a baseboard management controller (BMC) 124 that may be configured to enable communications (e.g., via Ethernet) with other modules or rack systems, to inquire about or answer inquiries regarding power status, temperature, or other conditions for various modules. The BMC 124 may, along with a management switch chip 126 (e.g., an Ethernet switch), enable Ethernet or other communications to other modules via the BPC 120. In an example embodiment, the BPC 120 may also be coupled to a high performance network chip 128 (e.g., an Ethernet or InfiniBand chip). The high performance network chip 128 may be a standard thirty six port chip and include sixteen ports assigned to communication with downstream processing modules via the BPC 120, with some or all of the remaining twenty ports being assigned to communication with external networks (e.g., via Ethernet), and/or with upstream switching modules. In an example embodiment, zero to two ports may be used for connection to an optional gateway module 130. The gateway module 130 may then connect to an Ethernet or other input/output interface to external networks. The other eighteen to twenty ports may be coupled to a fiber optic input/output interface 132 to connect to external networks and/or with upstream switching modules. In some embodiments, the other eighteen to twenty ports may be connected to the fiber optic input/output interface 132 via an optional electro-optic converter 134.

The cluster unit 28 is but one example of a cluster unit that may utilized in conjunction with the rack system 10. Cluster units may combine data networking, processing, and storage capacity in a variety of ways, using any variation in the types and numbers of chips integrated into any number of modules. As such, some cluster unit configurations may occupy only a single module bay, while others may occupy a contiguous group of two or more vertically stacked module bays. A cluster unit may include a network switch chip that supports a number of network endpoints. Based on the application, a larger or smaller number of processing and/or storage chips or modules may be connected to an endpoint of the network switch chip. For applications that require only a small amount of network throughput per unit of processing, a large number of processing chips or modules may be connected to a single network endpoint. For different applications that require a much larger amount of network throughput per unit of processing, a single processing chip or module per network endpoint may be connected, or the processor could be integrated directly onto the network chip. Similarly, for storage of relatively “cold” data, where each storage element is accessed relatively infrequently, a very large number of storage chips or modules may be connected to a single network endpoint. Conversely, for relatively “hot” data where each storage element is accessed very frequently, a single storage chip or module may be connected to a network endpoint, or the storage may be integrated with a processor chip into a single module, or into a module that includes a network chip.

Therefore, based on the particular application, optimized configurations of cluster units may be utilized. A cluster unit may, for example, take the form of a single module in a single bay like cluster switch 34 of FIG. 1, which could contain multiple complete clusters, each integrated onto a single chip combining all network switching, processing, and storage elements for a single cluster unit. On the other hand, a single cluster unit could occupy a large number of vertically contiguous bays interconnected via a single backplane. A central switch module like cluster switch 34 could contain a single network switch chip, and possibly also some number of processing chips and/or storage chips/units. Modules installed in bays above and below the central switch module could contain additional large numbers of processing chips and/or storage chips/units.

In instances where a cluster unit has processing and storage units that are not all integrated into the single central network switch chip, there may be a number of possible ways to partition the multiple chips in the cluster unit across multiple modules. For example, a single module may contain one or more complete cluster units, each of which has a single network chip and some number of surrounding processing and/or storage chips/units. Alternatively, for example, a single cluster unit with a single central module like cluster switch 34 may contain a single network chip (and possibly also some number of processing and/or storage chips/units), and the central cluster switch may be coupled to modules in the bays above and below this central module that contain additional processing chips, additional storage chips/units, or both. In this regard, for example, a central module with networking, processing, and storage may be coupled to modules in bays above and/or below the central module that include processing and storage capabilities. In another example, a central module with network and processing capabilities may be coupled to modules in bays above and/or below the central module that include storage only. In another example, a central module with network and storage capabilities may be coupled to modules in bays above and/or below the central module that include only processing capabilities. In yet another example, a central module with network only capabilities may be coupled to modules in bays above and/or below the central module that include storage only modules and processing only modules. For some applications, there may be significant cost advantages realized from combining all processing chips together with the network chip on a single Printed Circuit Board (PCB) in a single central network and processing module of a cluster unit. This configuration may permit the routing of all high-speed electrical networking signals between network chips and processing chips over a short distance at low cost on a single PCB, rather than routing these signals over longer distances at higher cost to separate modules connected via a backplane. In such a cluster unit design, if there is insufficient space in the central module for the required storage capacity, the storage elements may be located in storage only modules in bays above and/or below the central module. Because the electrical signaling needed between processor and storage may be lower speed and lower cost, relative to the signaling needed between network chip and a processor, it may be advantageous from a cost perspective to combine all processors together with the network chip on a single PCB in a single central module, and use backplane connections to carry processor-to-storage signaling, but not network chip-to-processor signaling.

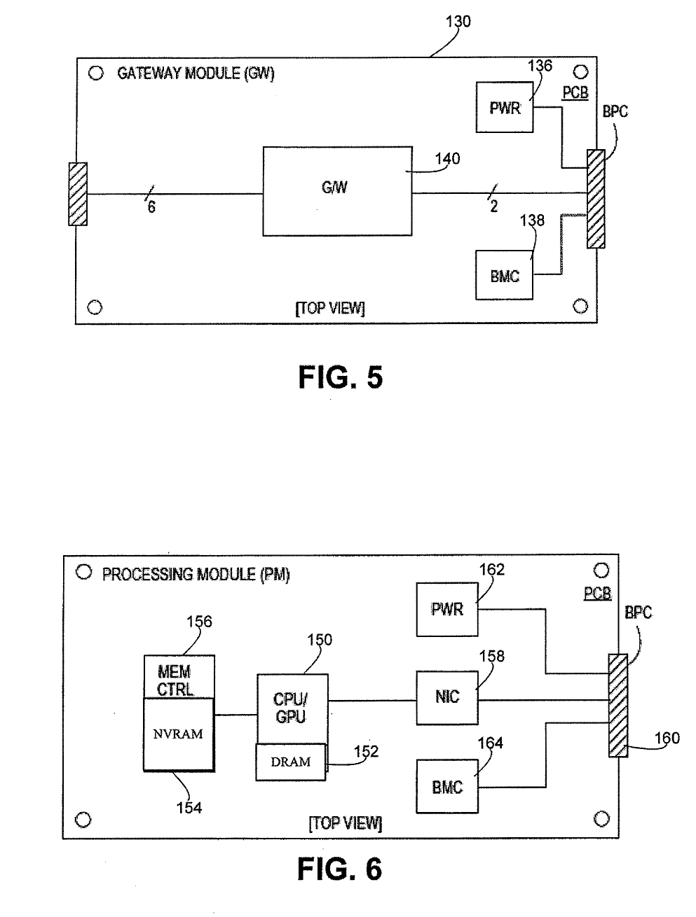

FIG. 5 illustrates an example of a gateway module according to an exemplary embodiment. As shown in FIG. 5, the gateway module 130 may also include a power module 136 and a baseboard management controller (BMC) 138 that may operate similarly to the corresponding power module 122 and BMC 124 described above. The gateway module 130 may also include a gateway chip 140 providing a connection to external networks (e.g., via Ethernet connection).

FIG. 6 illustrates an example of a processing module according to an exemplary embodiment. As shown in FIG. 6, the processing module may include a processor 150, volatile memory (e.g., DRAM 152), and non-volatile memory (e.g., NVRAM 154) that may be controlled by a memory controller 156. The processor 150 may be in communication with a network interface chip (NIC) 158 that may be a high performance network chip such as an Ethernet or InfiniBand chip. The NIC 158 may provide connections to a backplane connector (BPC) 160 that may be configured to enable the processing module to be mounted to the cluster unit backplane 38. The processing module may also include a power module 162 and a baseboard management controller (BMC) 164 that may operate similarly to the corresponding power module 122 and BMC 124 described above.

Returning to the discussion of FIG. 1, the cluster unit backplane 38 may be a single circuit board with connectors corresponding to their counterpart connectors on each module of the cluster unit 28, and the cluster unit backplane 38 may have a height of approximately the height of the (three) module bays 30. In other embodiments, the cluster unit backplane 38 may be composed of two or more circuit boards with corresponding connectors, or the cluster unit backplane 38 may be single circuit board that supports two or more cluster units (e.g., cluster unit 28) over a multitude of module bays.

The optional rack power section 19 of the rack system 10 may include rack power and management units 40, composed of two rack management modules 44 and a plurality of rack power modules 46 (e.g., RP01-RP16). In another embodiment, the rack management modules 44 and a corresponding rack management backplane (not shown) may be independent of the rack power unit 40 and may be included in the universal hardware platform 21. In one embodiment, there may be two modules per module bay, such as the two rack power modules in module bay 24 and the two rack management modules 44 in module bay 26.

The rack management modules 44 may provide network connectivity to every module installed in the rack system 10. This includes every module installed in the universal hardware platform 21, and every module of the rack power section 19. Management cabling 45 provides connectivity from the rack management modules 44 to devices external to the rack system 10, such as networked workstations or control panels (not shown). This connectivity may provide valuable diagnostic and failure data from the rack system 10, and in some embodiments provide an ability to control various service units and modules within the rack system 10.

As with the backplane boards of the universal hardware platform 21, the back plane area corresponding to the rack power section 19 may be utilized to fasten one or more backplane boards. In one embodiment, a rack power and management backplane 42 is a single backplane board with connectors corresponding to their counterpart connectors on each of the rack management modules 44 and the rack power modules 46 of the rack power and management unit 40. The rack power and management backplane 42 may then have a height of approximately the height of the collective module bays corresponding to the rack power and management unit 40. In other embodiments, the rack power and management backplane 42 may be composed of two or more circuit boards, with corresponding connectors.

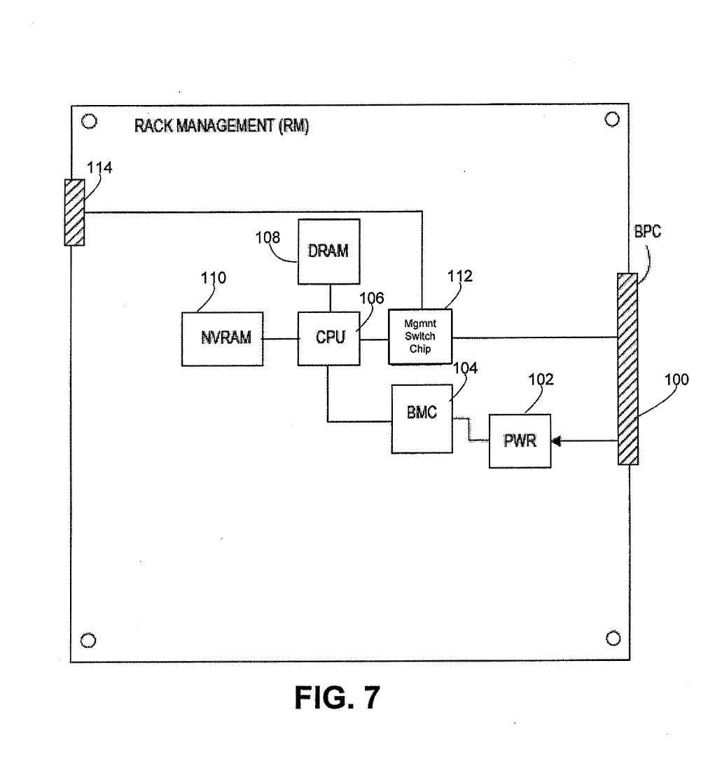

The rack management module 44 of one example embodiment is shown in FIG. 7. As shown in FIG. 7, the rack management module 44 may include a backplane connector (BPC) 100 that connects the rack management module 44 to the rack power and management backplane 42. A power module 102 may be coupled to the BPC 100 to bring in power from the rack power and management backplane 42. The power module 102 may be in communication with a baseboard management controller (BMC) 104 that may be configured to enable communications (e.g., via Ethernet) with other modules or rack systems, to inquire about or answer inquiries regarding power status, temperature or other conditions for various modules. The BMC 104 may be in communication with a processor (or CPU) 106 that may issue commands to rack service modules to manage operations of the rack system 10 (and/or cooperation with other rack systems). As such, for example, the processor 106 may be enabled to turn modules on or off, get information on module temperature, or acquire other information regarding module conditions and/or performance. The processor 106 may have access to volatile and/or non-volatile memory (e.g., DRAM 108 and NVRAM 110), and may be in communication with a management switch chip 112 (e.g., an Ethernet switch). The management switch chip 112 may be coupled to the BPC 100 (e.g., via 48 point to point connection ports), and/or external management devices (e.g., a higher level management computer) via an external link 114 (e.g., at the front of the module instead of at the back end).

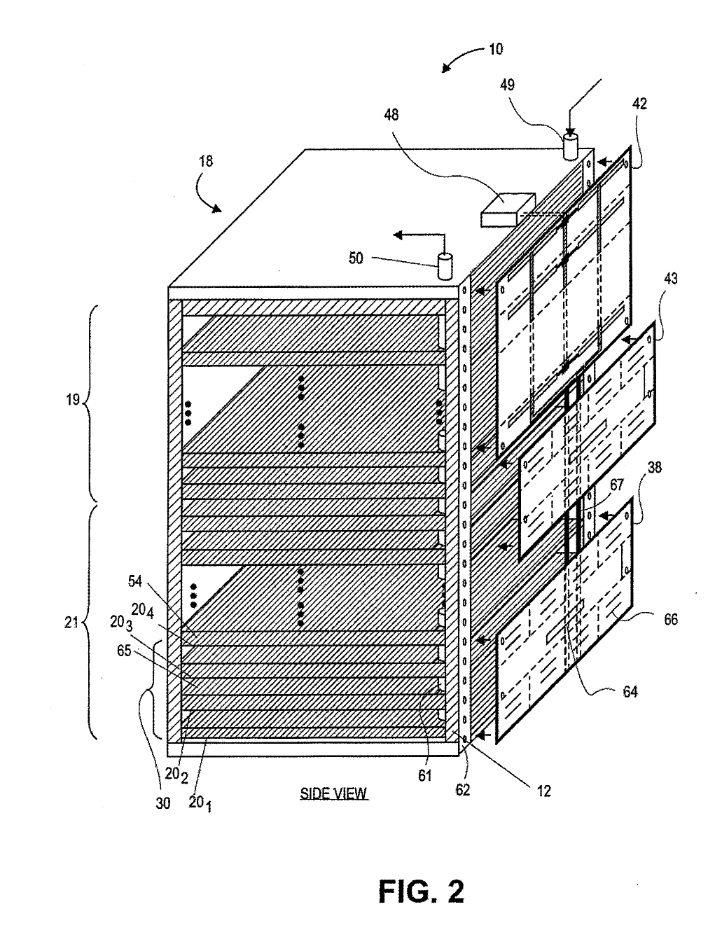

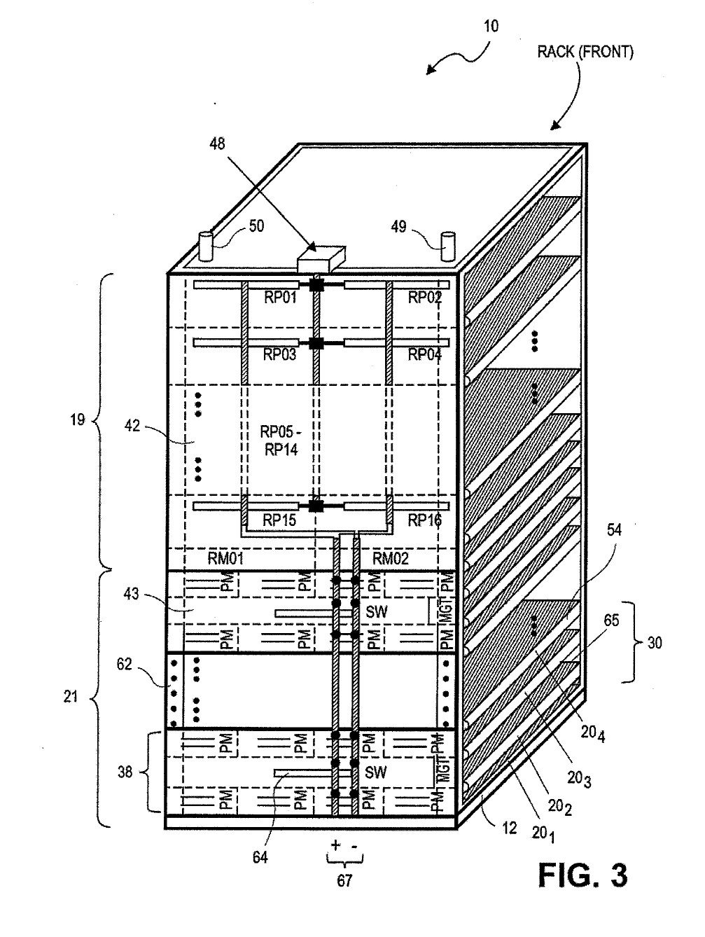

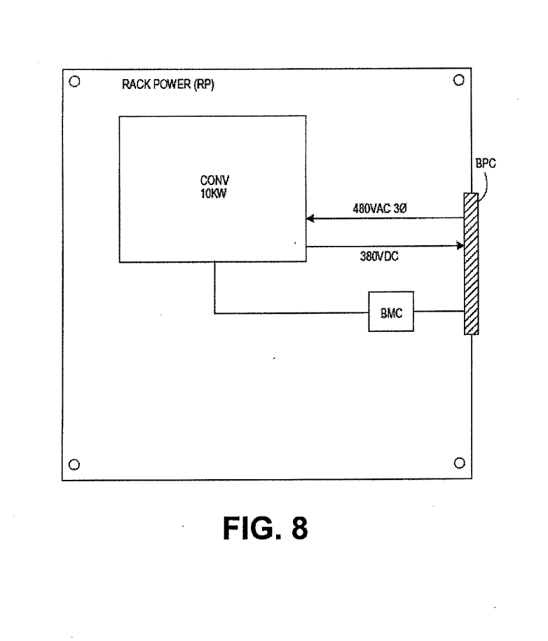

In one embodiment, the rack power modules 46 are connected to the power inlet 48 (See e.g., FIGS. 2 and 3), which may be configured to receive three-phase alternating current (AC) power from a source external to the rack system 10. The rack power modules 46 convert the three-phase AC into direct current (DC). For example, the rack power modules 46 may convert a 480 volt three-phase AC input to 380 volt DC for distribution in the rack system 10. FIG. 8 illustrates a block diagram of a rack power module according to an example embodiment. In this regard, the rack power module of FIG. 8 includes a backplane connector (BPC) that connects the rack power module to the backplane. The rack power module also includes a power converter for converting 480 volt three-phase AC input to 380 volt DC, and a baseboard management controller (BMC) that enables the rack power module to be addressed via a management network connection (e.g., Ethernet) for power status inquiries, temperature inquiries, and other requests. In one embodiment, the DC voltage from the rack power modules 46 is connected to power bus 67 (See e.g., FIGS. 2 and 3) running down from the rack power and management backplane 42 to other service unit backplanes, such as the cluster unit backplane 38.

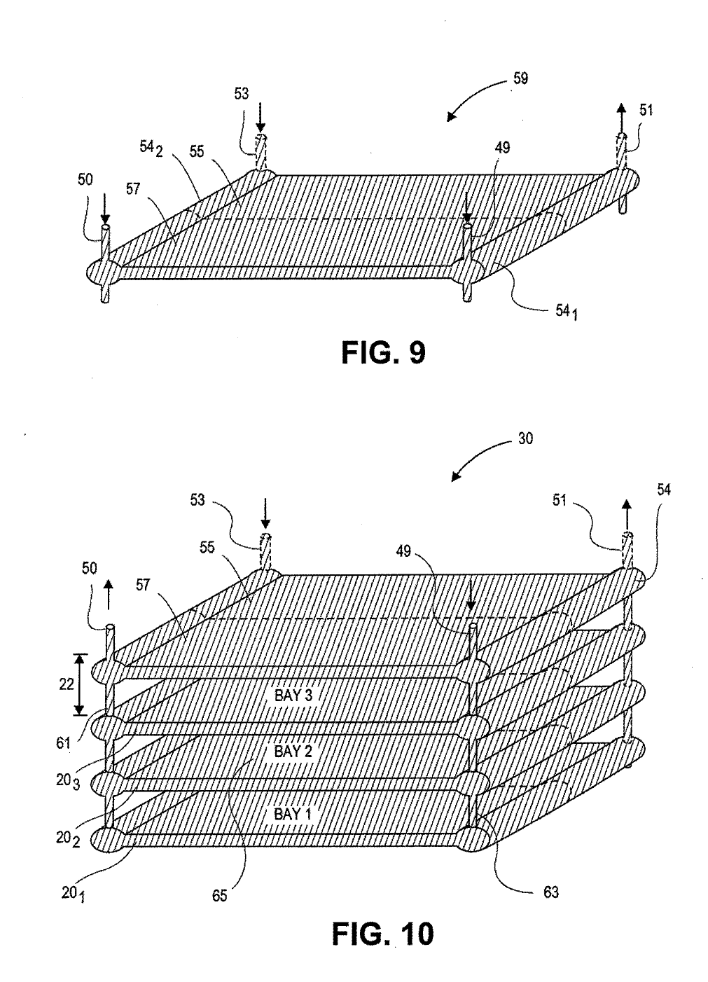

The rack system 10 may include a coolant system having a coolant inlet 49 and coolant outlet 50. The coolant inlet 49 and the coolant outlet 50 are connected to piping running down through each partition's coolant distribution nodes (e.g., coolant distribution node 54) to provide the coolant into and out of the cooled partitions. For example, coolant (e.g., refrigerant R-134a) flows into the coolant inlet 49, through a set of vertically spaced, 0.1 inch thick horizontal cooled partitions (discussed herein with reference to FIGS. 3 and 9) and out of the coolant outlet 50. The coolant may be provided, for example, from an external coolant pumping unit. As discussed above, the space between each pair of adjacent cooled partitions is a module bay. Waste heat is transferred via conduction, first from the components within each module (e.g., processing modules 32) to the module's top and bottom surfaces, and then to the cooled partitions at the top and bottom of the module bay (e.g., module bays 30). Other coolant distribution methods and hardware may also be used without departing from the scope of the embodiments disclosed herein.

In some example embodiments, instead of having refrigerant flowing into and out of coolant inlet 49 and out of coolant outlet 50 driven by external refrigerant pumping and heat rejection infrastructure, the refrigerant flow may be driven by one or more recirculation pumps integrated into rack system 10. Additionally, the refrigerant piping may travel from the rack (e.g., the top of the rack) to and from a heat rejection unit, which may be mounted on or near the rack system 10, e.g., directly on top of the rack, or in a separate location such as outdoors on a roof of a surrounding container or building.

According to some example embodiments, the heat rejection unit may be a refrigerant-to-water heat exchanger, which may be located close to the rack system 10 (e.g., mounted on the top of the rack system 10). A refrigerant-to-water heat exchanger, for example, mounted on the top of the rack system 10, may have cooling water flowing from an external cooling water supply line into an inlet pipe, and from an outlet pipe to an external cooling water return line. As such, the coolant inlet 49 and the coolant outlet 50 may be connected to the water supply and return lines, while refrigerant is used within the rack system 10 for cooling partitions 20. This refrigerant-to-water heat exchanger may be utilized when heat is being transferred into another useful application such as, for example, indoor space or water heating, or when there is a relatively large distance from the rack system to next point of heat transfer (e.g., to outdoor air).

Alternatively, in some example embodiments, the heat rejection unit may be a refrigerant-to-air heat exchanger. A refrigerant-to-air heat exchanger may utilize fan-driven forced convection of cooling air across refrigerant-filled coils, and may be located in an outdoor air environment separate from the rack system. For example, the refrigerant-to-air heat exchanger may be located on a roof of a surrounding container or building. In many instances, rejecting waste heat to outdoor air directly, eliminates the cost and complexity of the additional step of transferring heat to water and then finally to outdoor air. The use of a refrigerant-to-air heat exchanger may be advantageous in situations where there is a short distance from the rack system to the outdoor refrigerant-to-air heat exchanger.

To support the internal flow of refrigerant within the rack system 10, a mechanical equipment space, for example, at the bottom of the rack below the bottom-most module bay, may house a motor-driven refrigerant recirculation pump. Refrigerant (e.g., liquid refrigerant) may be forced upward from the pump outlet via a refrigerant-supply pipe network, into an inlet manifold on the edge (e.g., the left side) of each cooling partition 20 (see FIGS. 9 and 10) in the rack system 10. The refrigerant exiting the outlet manifold on the opposite edge (e.g., the right side) of each cooling partition may be a mixture of liquid and vapor, and the ratio of liquid to vapor at the outlet depends on the amount of heat that was absorbed by the cooling partition based on a local instantaneous heat load. Via a refrigerant-return pipe network connected to the outlet manifold of each cooling partition, liquid-phase refrigerant may drain down via gravity into the inlet of the recirculation pump at the bottom of the rack. In this same refrigerant-return pipe network, vapor-phase refrigerant may travel upward to the top of the rack and then through the heat-rejection unit, where the vapor-phase refrigerant may condense back to liquid and then drain down via gravity into the inlet of the recirculation pump at the bottom of the rack.

Thus, embodiments of the rack system 10 including one or all of the compact features based on modularity, cooling, power, pitch height, processing, storage, and networking, provide, among others, energy efficiency in system manufacturing, energy efficiency in system operation, cost efficiency in system manufacturing and installation, cost efficiency in system maintenance, space efficiency of system installations, and environmental impact efficiency throughout the system lifecycle.

FIG. 2 illustrates a portion of the side of the rack system 10, according to one embodiment. FIG. 2 shows the rack power section 19 and the universal hardware platform 21 as seen from an open side and rear perspective of the rack system 10. The three module bays of the module bays 30 are made up of four cooled partitions, cooled partitions 20₁, 20₂, 20₃, and 20₄. Each module bay includes two partitions, in this embodiment an upper and a lower partition. For example, module bay 65 is the middle module bay of the three module bays, module bays 30, and has cooled partition 20₂ as the lower cooled partition and 20₃ as the upper cooled partition. As will be discussed in further detail, functional modules may be inserted into module bays, such as module bay 65, and thermally couple to the cooled partitions to cool the modules during operation.

The coolant distribution node 54 is illustrated on cooled partition 20₄, and in this embodiment is connected to the coolant distribution nodes of other cooled partitions throughout the rack via coolant pipe 61 running up the height of the rack and to the coolant outlet 50. Similarly, a coolant pipe 63 (See e.g., FIG. 10) may be connected to the opposite end of each of the cooled partitions at a second coolant distribution node, and to the coolant inlet 49.

The perimeter frame 12 of the rack system 10 may include a backplane mounting surface 62 where the service unit backplanes are attached to the perimeter frame 12, such as the cluster unit backplanes 38 and 43 of the universal hardware platform 21, and the rack power and management backplane 42 of the rack power section 19. In various embodiments, the backplane mounting surface 62 may include mounting structures that conform to a multiple of a standard pitch size (P), such as pitch 22 shown in FIG. 1. The mounting structures on the surface of the service unit backplanes, as well as the backplanes themselves, may be configured to also conform with the standard pitch size. For example, the cluster unit backplane 38 may have a height of approximately the height of module bays 30, corresponding to a pitch of 3P, and accordingly the structures of the backplane mounting surface 62 are configured to align with the mounting structures of the cluster unit backplane 38.

In various embodiments, the mounting structures for the backplane mounting surface 62 and the service units (e.g., cluster unit 28) may be magnets, rails, indentations, protrusions, bolts, screws, or uniformly distributed holes that may be threaded or configured for a fastener (e.g., bolt, pin, etc.) to slide through, attach, or snap into. Embodiments incorporating the mounting structures set to a multiple of the pitch size, have the flexibility to include a multitude of backplanes corresponding to various functional types of service units that may be installed into the module bays of the universal hardware platform 21 of the rack system 10.

When mounted, the service unit backplanes provide a platform for the connectors of the modules (e.g., processing modules 36 of service unit 28) to couple with connectors of the service unit backplane, such as the connectors 64 and 66 of the cluster unit backplane 38 and the connectors associated with the modules of cluster unit 28 described herein. The connectors are not limited to any type, and each may be, for example, an edge connector, pin connector, optical connector, or any connector type or equivalent in the art. Because multiple modules may be installed into a single module bay, the cooled partitions may include removable, adjustable, or permanently fixed guides (e.g., flat brackets or rails) to assist with the proper alignment of the modules with the connectors of the backplane upon module insertion. In another embodiment, a module and backplane may include one or more guide pins and corresponding holes (not shown), respectively, to assist in module alignment.

FIG. 3 is an embodiment of rack system 10 illustrating the rear portion and the open side of the rack. As shown, FIG. 3 represents only a portion of the entire rack system 10, and specifically, only portions of the rack power section 19 and the universal hardware platform 21. This embodiment illustrates the power inlet 48 coupled to a power bus 67 via the rack power and management backplane 42, which as previously mentioned may convert AC power from the power inlet 48 to DC power for distribution to the service units via the service unit backplanes of the universal hardware platform 21.

In one embodiment, the power bus 67 includes two solid conductors; a negative or ground lead and a positive voltage lead connected to the rack power and management backplane 42 as shown. The power bus 67 may be rigidly fixed to the rack power and management backplane 42, or may only make an electrical connection but be rigidly fixed to the backplanes as needed, such as to the cluster unit backplanes 38 and 43. In another embodiment where DC power is supplied directly to the power inlet 48, the power bus 67 may be insulated and rigidly fixed to the rack system 10. Regardless of the embodiment, the power bus 67 is configured to provide power to any functional type of backplane mounted in the universal hardware platform 21. The conductors of the power bus 67 may be electrically connected to the service unit backplanes by various connector types. For example, the power bus 67 may be a metallic bar which may connect to each backplane using a bolt and a clamp, such as a D-clamp.

FIG. 3 also illustrates another view of the cooled partitions of the rack system 10. This embodiment shows the coolant distribution node 54 that is part of the cooled partitions shown, such as the cooled partitions 20₁, 20₂, 20₃, and 20₄ of module bays 30, and also shows a side view of the middle module bay, module bay 65. As discussed herein, the coolant distribution node 54 may be connected to the coolant distribution nodes of the other cooled partitions via coolant pipes 61 and 63 (see e.g., FIGS. 2 and 10) running up the rack and to the coolant inlet 49 and the coolant outlet 50.

FIG. 9 is an embodiment of a cooled partition 59. The cooled partition 59 includes coolant distribution nodes 54₁ and 54₂, which are connected to the coolant inlet 49 and the coolant outlet 50, respectively. The cooled partition 59 internally includes channels (not shown) that facilitate coolant flow between the coolant distribution nodes 54₁ and 54₂ to cool each side of the cooled partition 59. The internal channels may be configured in any suitable way known in the art, such as a maze of veins composed of flattened tubing, etc. The coolant distribution nodes 54₁ and 54₂ may include additional structures to limit or equalize the rate and distribution of coolant flow along each axis of the coolant distribution node and through the cooled partition. Additionally, the coolant inlet 49 and the coolant outlet 50 may be located diagonally opposite to each other, depending on the rack design and the channel design through the cooled partition 59.

In another embodiment, the cooled partition 59 may be divided into two portions, partition portion 55 and partition portion 57. Partition portion 57 includes existing coolant inlet 49 and coolant outlet 50. However, the partition portion 55 includes its own coolant outlet 51 and coolant inlet 53. The partition portions 55 and 57 may be independent of each other, each with its own coolant flow from inlet to outlet. For example, the coolant flow may enter into coolant inlet 49 of partition portion 57, work its way through cooling channels and out of the coolant outlet 50. Similarly, coolant flow may enter coolant inlet 53 of partition portion 55, then travel through its internal cooling channels and out of coolant outlet 51. In another embodiment, the coolant inlet 49 and the coolant inlet 53 may be on the same side of the partition portion 55 and the partition portion 57, respectively. Having the coolant inlets and outlets on opposite corners may have beneficial cooling characteristics in having a more balanced heat dissipation throughout the cooled partition 59.

In another embodiment, the partition portions 55 and 57 are connected such that coolant may flow from one partition portion to the next through either one or both of the coolant distribution nodes 54₁ and 54₂, and through each partition portions' cooling channels. In this embodiment, based on known coolant flow characteristics, it may be more beneficial to have the coolant inlet 49 and the coolant inlet 53 both on the same side of the partition portion 55 and the partition portion 57, and similarly the outlets 50 and 51 both on the opposite side of the partition portions 55 and 57.

One concern about high-density direct-conduction cooling systems, is that the heat-dissipating components may need to be shut down quickly if coolant flow stops due to, for example, mechanical failure in the cooling system or required maintenance activities. To assist in addressing this concern, multiple independent and redundant coolant circuits may be integrated into the rack system 10. Therefore, if coolant flow in one circuit stops due to, for example, mechanical failure or required maintenance activities, the remaining coolant circuits may continue to function, thereby enabling continued operation of the heat-dissipating components.

In this regard, each cooling partition 20 may be divided into two or more separate strips, with each strip traveling from left to right across the rack. Each independent strip may be connected to a single coolant circuit. Multiple independent coolant circuits may be provided in the rack, arranged such that if cooling in a single coolant circuit is lost due to failure or shutdown, every cooling partition 20 in the rack will continue to provide cooling via at least one strip connected to a still-functioning coolant circuit. For example, a dual redundant configuration could have one strip traveling from left to right near the front of the rack system, and in the same plane another separate strip traveling from left to right near the rear of the rack system 10. In this example configuration, the effectiveness of cooling redundancy can be enhanced via front-to-back heat-spreading thermal plates forming the top and bottom surfaces of modules (e.g., processing modules 36 of service unit 28). Such plates can make it possible for all components in the module to be cooled simultaneously and independently by each of the separate cooling-partition strips in a redundant configuration. If any one of the redundant strips stops cooling temporarily due to, for example, a mechanical failure or required maintenance activities, all components in the module can continue to be cooled, albeit possibly at reduced cooling capacity that might necessitate load-shedding or other means to temporarily reduce power dissipation within the module.

Additional cooling system redundancies can also be integrated in the rack system. For example, multiple redundant recirculation pumps at the bottom of the rack may be included (e.g., one for each cooling circuit), and multiple redundant refrigerant-to-water or refrigerant-to-air heat exchangers may be included, possibly installed on the top of the rack system.

FIG. 10 is an embodiment of the cooled partitions 20₁, 20₂, 20₃, and 20₄ of module bays 30 outside of the rack system 10, and provides another illustration of the module bay 65. Each cooled partition may have the same functionality as described in FIG. 9 with respect to cooled partition 59. Each cooled partition is physically connected by the coolant pipe 61 and the coolant pipe 63, which provide system wide coolant flow between all cooled partitions within the rack system 10. As with the cooling partition 59 of FIG. 9, in another embodiment the cooled partitions 20₁, 20₂, 20₃, and 20₄ may have an additional coolant outlet 51 and coolant inlet 53 and associated piping similar to coolant pipes 61 and 63. In other embodiments, the configuration of the inlets and outlets may vary depending on the desired coolant flow design. For example, the two inlets may be on diagonally opposite corners or on the same side, depending on the embodiment designed to, such as including partition portions, etc., as discussed herein with reference to FIG. 9.

In one embodiment, the bottom and top surfaces of the cooled partitions 20₁, 20₂, 20₃, and 20₄ are heat conductive surfaces. Because coolant flows between these surfaces, they are suited to conduct heat away from any fixture or apparatus placed in proximity to or in contact with either the top or bottom surface of the cooled partitions, such as the surfaces of cooled partitions 20₂ and 20₃ of module bay 65. In various embodiments, the heat conductive surfaces may be composed of any combination of many heat conductive materials known in the art, such as aluminum alloy, copper, etc. In another embodiment, the heat conductive surfaces may be a mixture of heat conducting materials and insulators, which may be specifically configured to concentrate the conductive cooling to specific areas of the apparatus near or in proximity to the heat conductive surface.

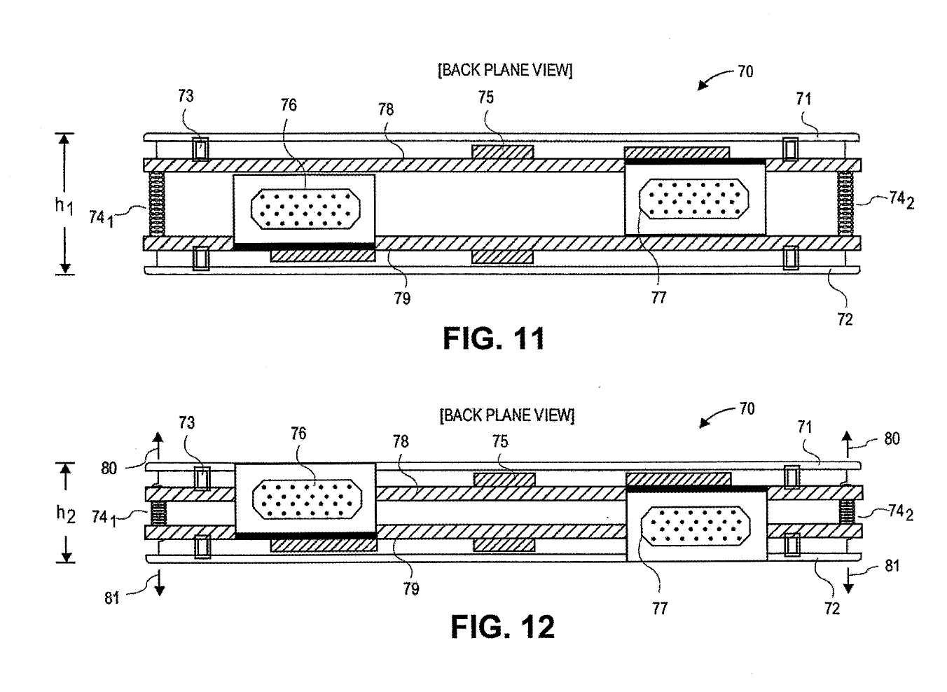

FIGS. 11 and 12 are each embodiments of a module fixture 70 that may include circuit boards and components that make up a functional module in a service unit, such as the four processing modules 32 insertable into the module bay 65 as discussed with reference to FIGS. 1, 2, and 10. The module fixture 70 includes thermal plates 71 and 72, fasteners 73, tensioners 74₁ and 74₂, component 75, connector 76, connector 77, and component boards 78 and 79.

In one embodiment, the component boards 78 and 79 are multi-layered printed circuit boards (PCBs) and are configured to include connectors and components, such as component 75, to form a functional circuit. In various embodiments, the component board 78 and the component board 79 may have the same or different layouts and functionality. The component boards 78 and 79 may include the connector 77 and the connector 76, respectively, to provide input and output via a connection to the backplane (e.g., cluster unit backplane 38) through pins or other connector types known in the art. Component 75 is merely an example component, and it can be appreciated that a component board may include many components of various sizes, shapes, and functions that all may receive the unique benefits of the cooling, networking, power, management, and form factor of the rack system 10.

The component board 78 may be mounted to the thermal plate 71 using fasteners 73 and, as discussed herein, will be in thermal contact with at least one cooled partition when installed into the rack system 10. In one embodiment, the fasteners 73 have a built in standoff that permits the boards' components (e.g., component 75) to be in close enough proximity to the thermal plate 71 to create a thermal coupling to the component 75 and the component board 78. In one embodiment, the component board 79 is opposite to the component board 78, and may be mounted and thermally coupled to the thermal plate 72 in a similar fashion as component board 78 to thermal plate 71.

Because of the thermal coupling of the thermal plates 71 and 72—which are cooled by the cooling partitions of the rack system 10—and the components of the attached boards, (e.g., component board 78 and component 75) there may be no need to attach heat dissipating elements, such as heat sinks or heat spreaders, directly to the individual components. This allows the module fixture 70 to have a lower profile, permitting a higher density of module fixtures, components, and functionality in a single rack system, such as the rack system 10 and in particular the portion that is the universal hardware platform 21.

In another embodiment, if a component is sufficiently taller than another component mounted on the same component board, the lower height component may not have a sufficient thermal coupling to the thermal plate for proper cooling. In this case, the lower height component may include one or more additional heat-conducting elements to ensure an adequate thermal coupling to the thermal plate.

In one embodiment, the thermal coupling of the thermal plates 71 and 72 of the module fixture 70 is based on direct contact of each thermal plate to its respective cooled partition, such as the module bay 65 which includes cooled partitions 20₃ and 20₄ shown in FIGS. 2, 3, and 10 above. To facilitate the direct contact, thermal plates 71 and 72 may each connect to an end of a tensioning device, such as tensioners 74₁ and 74₂. In one embodiment, the tensioners are positioned on each side and near the edges of the thermal plates 71 and 72. For example, tensioners 74₁ and 74₂ may be springs in an uncompressed state resulting in a module fixture height h₁, as shown in FIG. 11, where h₁ is larger than the height of the module bay 65 including cooled partitions 20₃ and 20₄.

FIG. 12 illustrates the module fixture 70 when the thermal plates 71 and 72 are compressed towards each other to a height of h₂, where h₂ is less than or equal to the height or distance between the cooled partitions 20₃ and 20₄ of the module bay 65. Thus, when the module fixture is inserted into the module bay 65 there is an outward force 80 and an outward force 81 created by the compressed tensioners 74₁ and 74₂. These outward forces provide a physical and thermal contact between the cooled partitions 20₃ and 20₄ and the thermal plates 71 and 72. As coolant flows through each partition, as described with respect to FIG. 10, it conductively cools the boards and components of the module fixture 70.

The tensioners 74₁ and 74₂ may be of any type of spring or material that provides a force enhancing contact between the thermal plates and the cooling partitions. The tensioners 74₁ and 74₂ may be located anywhere between the thermal plates 71 and 72, including the corners, the edges, or the interior, and have no limit on how much they may compress or uncompress. For example, the difference between h₁ and h₂ may be as small as a few millimeters, or as large as several centimeters. In other embodiments, the tensioners 74₁ and 74₂ may pass through the mounted component boards, or be located between and coupled to the component boards, or any combination thereof. The tensioners may be affixed to the thermal plates or boards by any fastening hardware, such as screws, pins, clips, etc.

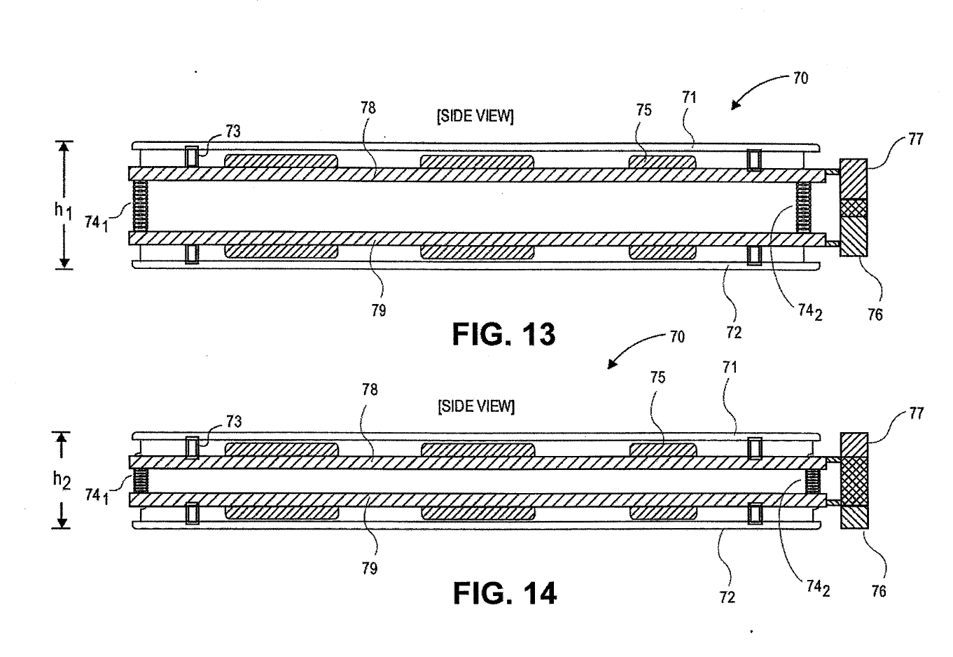

FIGS. 13 and 14 are embodiments of the module fixture 70 from a side view, in an uncompressed and compressed state respectively. As shown in FIGS. 11 and 12, the connectors 76 and 77 do not overlap, and in this embodiment are on different sides as seen from the back plane view. FIGS. 13 and 14 further illustrate that the connectors 76 and 77 extend out from the edges of the thermal plates 71 and 72, such that they may overlap the thermal plates when the module fixture 70 is compressed down to the height of h₂. For example, when the module fixture 70 is compressed down to the height of h₂, the connector 76 of the bottom component board 79 is relatively flush with the thermal plate 71 on top, and the connector 77 of the top component board 78 is relatively flush with the thermal plate 72 on the bottom. In this particular embodiment, the connectors 76 and 77 will determine the minimum h₂, or in other words, how much the fixture 70 may be compressed. Maximizing the allowable compression of fixture 70 enables the smallest possible pitch (P) between cooling partitions, and the highest possible density of functional components in the rack system. This is particularly important in the universal hardware platform portion 21 of the rack system 10.

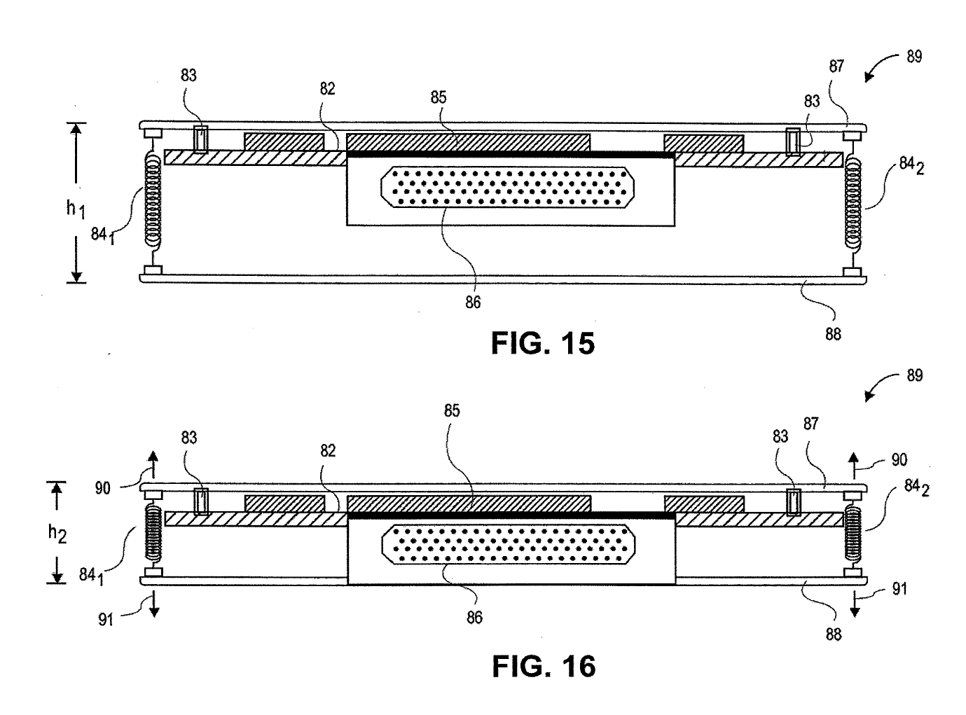

FIGS. 15 and 16 are each embodiments of a module fixture 89 for a rack power board insertable into the rack power section 19 of the rack system 10. The module fixture 89 includes thermal plates 87 and 88, fasteners 83, tensioners 84₁ and 84₂, component 85, connector 86, and component board 82.

In a similar way as described above with respect to the module fixture 70 in FIGS. 11 and 12, when the module fixture is inserted into a module bay in the rack power section 19 there is an outward force 90 and an outward force 91 created by the compressed tensioners 84₁ and 84₂. These outward forces enhance the physical and thermal contact between the cooled partitions of the rack power section 19 and the thermal plates 87 and 88. Therefore, the component board 82 and components (e.g., component 85) of the module fixture 89 are conductively cooled as coolant flows through the relevant cooled partitions.

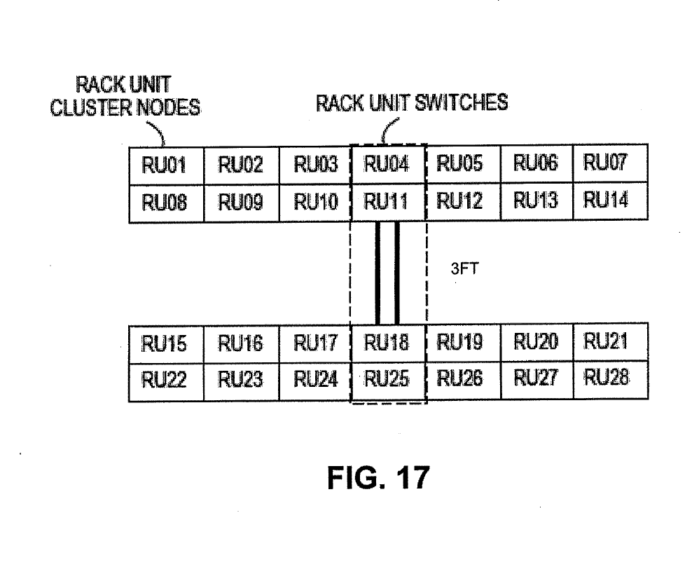

The embodiments described above and otherwise herein may provide for compact provision of network switching, processing, and storage resources with efficient heat removal within a rack system. In some situations, it may be desirable to provide a highly robust computing environment (e.g., a supercomputer or cloud computing system) by ganging together resources from multiple rack systems. In an example embodiment, an architecture for providing a robust computing system can be provided by employing a topology as described herein. FIG. 17 illustrates an arrangement of a plurality of rack units (e.g., rack system 10) to provide interconnection thereof for a robust computing environment according to an example embodiment. In this regard, twenty-eight rack units (RU01 to RU28) are provided in two sets of adjacent rows of seven units each. In this example, the sets are shown such that the units in adjacent rows are back to back with approximately three feet between the two sets. However, any other suitable arrangement could alternatively be provided.

In the example embodiment of FIG. 17, four of the rack units (e.g., RU04, RU11, RU18, and RU25) may be configured as rack unit switches. The twenty four rack units that are not rack unit switches may each be configured with twenty seven cluster units (e.g., instances of cluster unit 28) as rack unit cluster nodes. Meanwhile, the four rack unit switches (e.g., RU04, RU11, RU18, and RU25) may each have four switch units therein. The switch units in each of the four rack unit switches may be utilized to provide central switching functionality to interconnect all of the rack unit cluster nodes.

In an exemplary embodiment, since each of the rack unit cluster nodes includes twenty seven cluster units, with sixteen internal processing units and sixteen external network cables per cluster unit, there will be 432 cables leaving each rack unit cluster node for networking purposes (e.g., via net 52). Of the 432 cables from each rack unit cluster node, one quarter (or 108) of the cables may be coupled to each respective rack unit switch. Each rack unit switch may then receive 2,592 total cables (108 times 24). Since there are four rack unit switches, this example embodiment includes 10,368 total processing units (2,592 times 4) that may be interconnected via the rack unit switches.

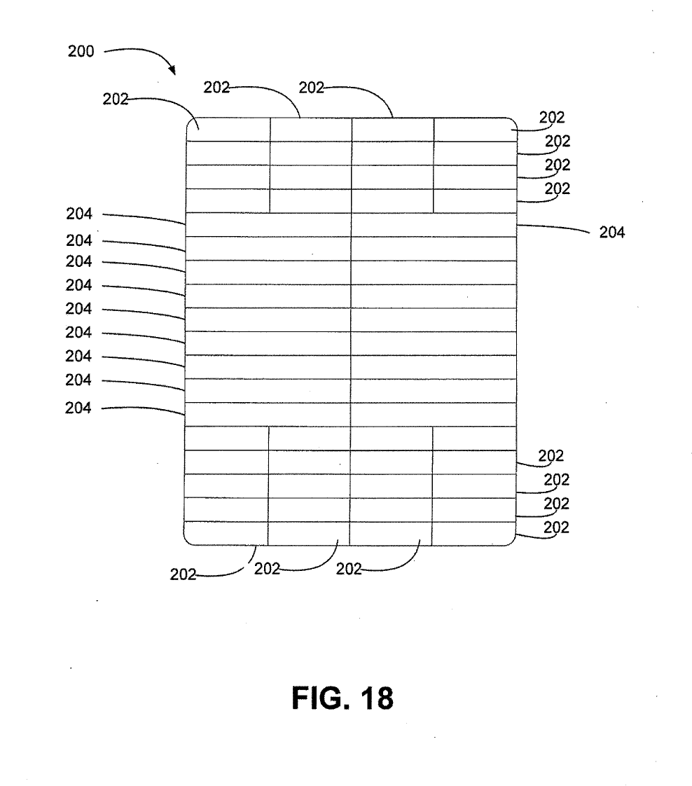

In an exemplary embodiment, each rack unit switch may further include four switch units 200 therein (for a total of sixteen switch units 200 within the system shown in FIG. 17). The switch units 200 may include leaf modules 202 and spine modules 204. An example architecture of the switch unit 200 is shown in FIG. 18. As shown in FIG. 18, the spine modules 204 may be arranged substantially in a two by nine matrix, for a total of eighteen spine modules 204. Meanwhile, the leaf modules 202 may be distributed into two matrices, including a four by four matrix and a four by five matrix, that may be separated from each other by the matrix of spine modules 204, for a total of thirty six leaf modules 202. Other arrangements are also possible.

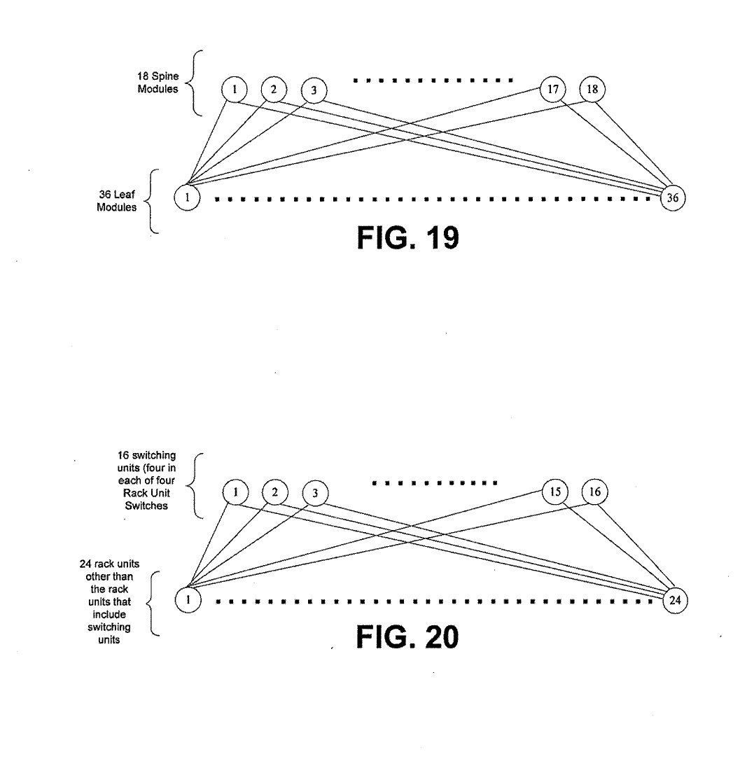

Each of the leaf modules 202 may be connected to each of the spine modules 204, to create a 648 port switch unit. FIG. 19 illustrates an exemplary internal topology for the switch unit 200. As shown in FIG. 19, each of 18 spine modules (e.g., the spine modules 204) that are represented by respective numbered circles (with dots representing some spine modules 204 to simplify the figure to enhance understanding) is connected to each of 36 leaf modules (e.g., leaf modules 202) within each switch unit 200. This topology provides a total of 648 ports that are interconnected in a robust switching network. Each leaf module (e.g., leaf modules 202) includes 18 ports to connect to each respective one of the 18 spine modules (e.g., spine modules 204), and 18 ports to connect via front-panel ports and cables to rack unit cluster nodes. Meanwhile, each spine module (e.g., spine modules 204) includes 36 ports to connect to each respective one of the 36 leaf modules (e.g., leaf modules 202). In some embodiments, the connections between leaf and spine modules may be made via backplane. In other embodiments, some or all of these connections may instead be made via front-panel ports on the leaf and spine modules, with cables interconnecting these ports.

FIG. 20 illustrates an exemplary topology for the connection of twenty-four rack unit cluster nodes (e.g., RU01 to RU28 other than RU04, RU11, RU18, and RU25) via the four rack unit switches (e.g., RU04, RU11, RU18, and RU25). Since each of the rack unit switches (e.g., RU04, RU11, RU18, and RU25) includes four switch units (e.g., switch unit 200), there are a total of sixteen switch units that are represented by respective numbered circles (with dots representing some switch units to simplify the figure to enhance understanding). Each of the 27 cluster units inside each rack unit cluster node has a single cable connection to each of the sixteen switch units. For each of the twenty-four rack unit cluster nodes, this results in sixteen 27-cable bundles exiting the rack unit cluster node, one bundle for each of the sixteen switch units. Using the combination of topologies shown in FIGS. 19 and 20, embodiments of the present invention may be enabled to interconnect, via a robust switching mechanism, every processor within every rack unit.

While FIGS. 19 and 20 illustrate an exemplary network based on, for example, the Clos topology, other network topologies such as the dragonfly topology may alternatively be employed. Furthermore, although FIGS. 19 and 20 illustrate one specific example with 4 rack unit switches and 24 rack unit cluster nodes, the principles described with respect to these figures may be generally applied to other embodiments as well.

In the illustrated specific example, each rack unit switch includes four switch units, and each switch unit includes 648 ports, based on an internal implementation using 36-port single-chip switching elements. In the example, each rack unit cluster node has a total of 432 ports originating from a total of 27 cluster units. The ports of the rack unit switches may be coupled to the ports of the rack unit cluster nodes, to create a network architecture. In such a system, for example, a plurality of cluster units may be included within each respective rack unit cluster node (e.g., 27 cluster units each having 8 processing modules containing two processing units, for a total of 432 processing units). In the example, each rack unit switch receives ¼ of the 432 cables from each of the rack unit cluster nodes. Thus, each exemplary rack unit switch receives 108 cables from each of the 24 rack unit cluster nodes in the example, such that a total of 10,368 processing units are interconnected via the rack unit switches.

The physical architecture of a switch unit may include spine modules and leaf modules that are interconnected such that each spine module is directly connected to each leaf module. Cables from the rack unit cluster nodes may be divided up similarly among the switch units (16 in the illustrated example). In some cases, at least some of the cable ports of the rack unit switches may be multiplexed (e.g., such that a 6 port cable connector set supports 3 channels for each port, to effectively define 18 ports).

More generally, when designing and configuring some example embodiments of the present invention, such as the system illustrated in FIGS. 19 and 20, it may be advantageous to select the numbers of various elements such that certain specific numerical relationships are established, either exactly or approximately. The following examples of such relationships apply to embodiments that use Clos topology and a single chip switching element with M ports, however, the examples may also be applied to other topologies. First, the total number of ports in all rack unit switches, the total number of ports in all rack unit cluster nodes, and the total number of processing units in the system, may all be approximately equal to each other, and less than or equal to M³/4. Second, the total number of ports in each of the switch units in a rack unit switch may equal M²/2. Third, the total number of ports in each cluster switch may be less than or equal to M. Fourth, the total number of processing units in each cluster unit may be equal to the total number of cable connections from the cluster unit to the rack unit switches, and less than or equal to M/2.

The embodiments illustrated in FIGS. 1 to 3 may provide for compact provision of network switching, processing, and storage resources with efficient heat removal. In some situations the provision of these characteristics may be accompanied by a requirement for a relatively large number of cables to enable communications between different rack systems 10 and perhaps also external devices or networks. If cables or network lines were simply routed along the perimeter frame 12, and excess cable was not properly managed, heat removal efficiency could be reduced, and/or general disorder could exist among the cables. Accordingly, some embodiments of the present invention may provide a cable slack management system for handling excess cable or cable slack.

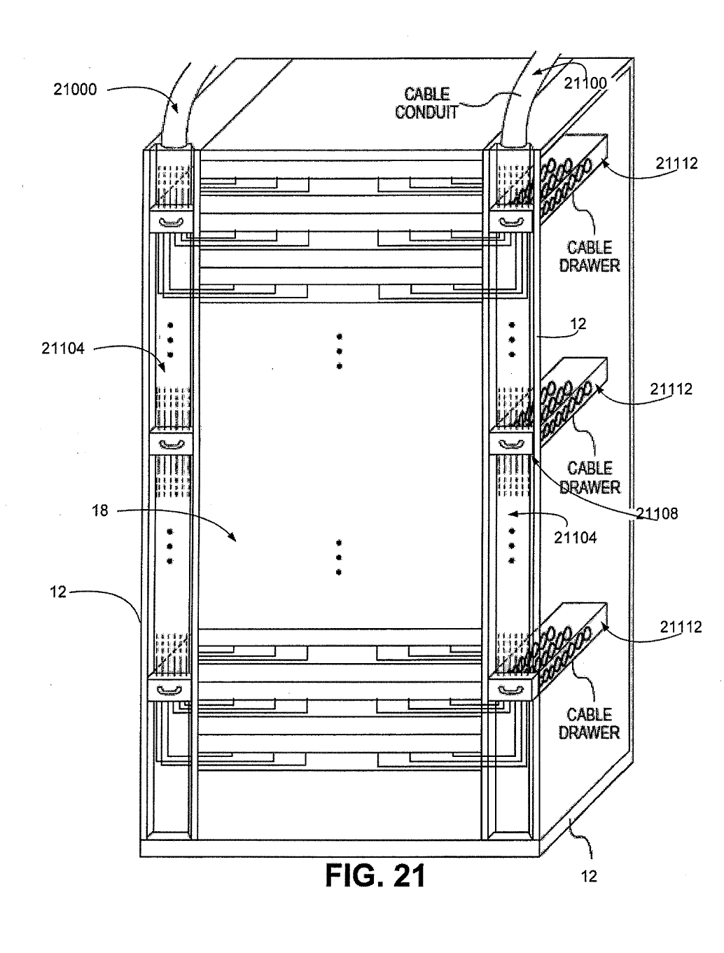

FIG. 21 illustrates an example of a cable slack management system, in accordance with an example embodiment. In some embodiments, cabling may be provided in a cable conduit 21100 that may enter the rack system 10 from above (e.g., via the rack top 16) into the perimeter frame 12. Cable may then proceed down the perimeter frame 12 via a cable way 21104. The cable way 21104 may extend down the length of the interior portion of the perimeter frame 12 to avoid interference with the service units of the rack system 10. In some embodiments, the cable way 21104 may extend down either or both members of the perimeter frame 12 that are positioned in the rack front 18. In an exemplary embodiment, the perimeter frame 12 may include one or more drawer enclosures 21108 positioned in the perimeter frame to receive a cable drawer 21112. In an exemplary embodiment, the drawer enclosures 21108 may be orifices within the perimeter frame 12 of the rack front 18 that permit insertion of corresponding cable drawers 21112 within the rack system 10 in a direction that is substantially normal to a plane of the rack front 18. Thus, the individual frame members that form the front portion of the rack system 10 may be coupled to the drawer enclosures 21108 in order to receive the cable drawers 21112 in a location that is easily accessible to users.

Although FIG. 21 shows six cable drawers 21112 positioned substantially equidistant from one another and symmetrical with respect to a centerline of the rack front 18, any number of cable drawers 21112 could be used, and the cable drawers 21112 could be positioned in any desirable way. The cable drawers 21112 may then be employed to contain cable slack therein, to prevent excess cable from being positioned within the rack system 10 in an unorganized fashion. The cable drawers 21112 may be removable from the corresponding drawer enclosures 21108, or at least be extendable therefrom in order to permit access to the inside of the cable drawers 21112. Although the above description refers to “drawer” enclosures and cable “drawers”, it should be noted that the cable slack could be managed in any cable management module, and thus the term “drawer” is used merely for exemplary purposes. The cable management module may be any retractable apparatus that has at least a frame (with or without any sidewalls and/or top/bottom walls) that is capable of supporting a structure or structures for permitting cable to be wound around the structure(s) to take up cable slack, as described above.

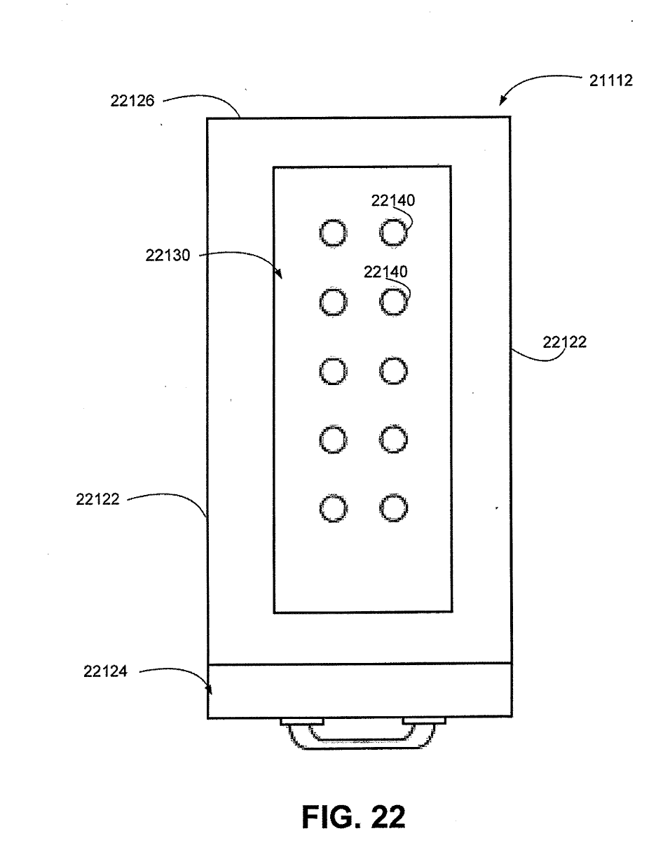

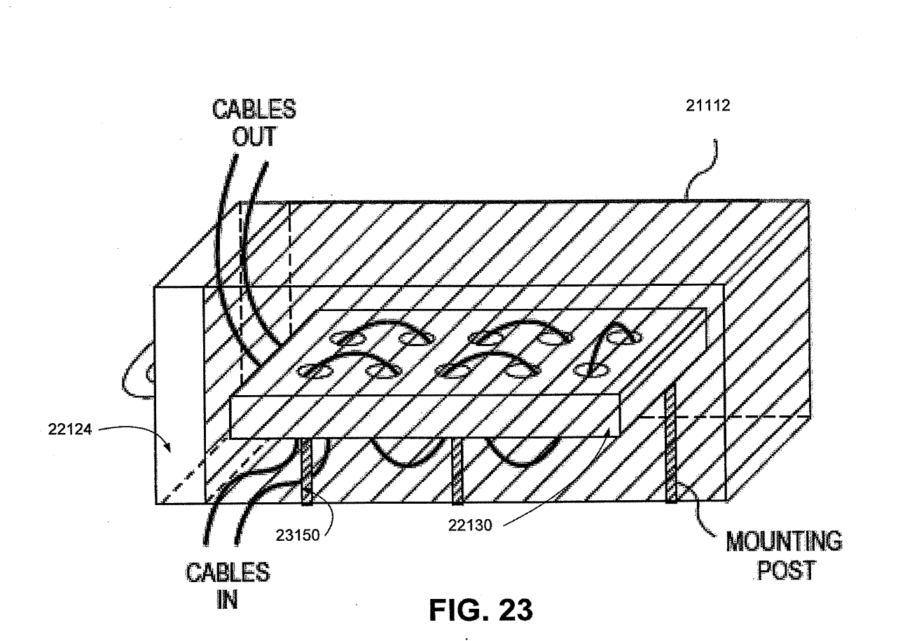

FIG. 22 shows a top view of the cable drawer 21112, according to one example embodiment. FIG. 23 shows a side view of the cable drawer 21112 with transparent side members to permit viewing of the contents of the cable drawer 21112, for ease of explanation. As shown in FIGS. 22 and 23, the cable drawer 21112 may include a plurality of members positioned together to define the cable drawer 21112. In an example embodiment, the cable drawer may include a bottom member 22120 that supports two side members 22122 that extend perpendicular to a plane of the bottom member 22120 from opposite edges of the bottom member 22120 relative to the longitudinal length of the bottom member 22120. A front member 22124 and a back member 22126 may also extend from the bottom member 22120 in a direction perpendicular to the plane of the bottom member 22120 from opposite distal ends of the bottom member 22120. The side members 22122 may each abut respective opposite edges of the front member 22124 and the back member 22126 to define a containment volume within the cable drawer 21112. In some embodiments, the cable drawer 21112 may therefore have no top member, to permit easy viewing and/or access to cable portions within the cable drawer 21112. However, in embodiments where a top member is included, the top member may provide partial coverage of the top of the cable drawer 21112, or include an opening to receive cable into the cable drawer 21112. In any case, cable may enter into the cable drawer 21112 via an open top of the cable drawer 21112 (or an opening in the top member if one is included), and the cable may exit the cable drawer 21112 via an opening in the bottom member 22120, as shown in FIG. 23.

In an example embodiment, one or more of the side members 22122, the front member 22124, and the back member 22126, may be coupled to the bottom member 22120 via a hinge assembly or other flexible coupling. The hinge assembly or flexible coupling may enable the corresponding members to be tilted away from the interior or center of the cable drawer 21112, to enhance access to the cable drawer 21112 to enable twining or winding of cables within the cable drawer 21112. In an example embodiment, the cable drawer 21112 may house a planar surface 22130 including multiple holes or orifices 22140 within the planar surface. The orifices 22140 may be used to twine or wind cable in and out to provide a holding mechanism for excess or slack cable. Any pattern for twining the slack cable may be used. Thus, for example, in some cases, multiple cable passes through the orifices 22140 may be employed (if cable diameter relative to orifice diameter permits), while in other cases only a single pass through each orifice may be used, dependent upon the length of the slack cable. Meanwhile, in still other cases, some orifices 22140 may not have cable passed through them at all, dependent again upon the length of the slack cable.

In some embodiments, the planar surface 22130 may be mounted to the front member 22124. The mounting to the front member 22124 may be a rigid mounting or a flexible mounting. For example, in some embodiments, the front member 22124 may be attached to the planar surface 22130 via a flexible coupling or hinge. The flexible coupling or hinge may enable the planar surface 22130 to be tilted out of the cable drawer 21112, to enhance access to cables therein.

In some examples, the planar surface 22130 may rest on mounting posts 23150. The mounting posts 23150 may extend perpendicularly from a surface of the bottom member 22120 and form a base upon which the planar surface 22130 may be mounted. The mounting posts 23150 may be used in connection with the hinge or flexible mounting to the front member 22124 described above, or may be used when the planar surface 22130 is rigidly mounted to the front member 124. In some embodiments, the mounting posts 23150 may be employed in situations where there is no connection between the planar surface 22130 and the front member 22124 as well.

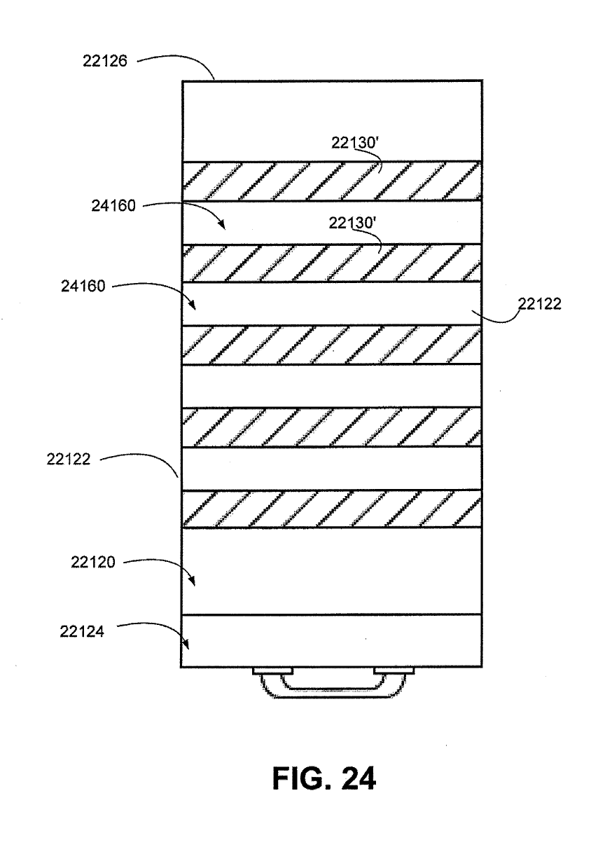

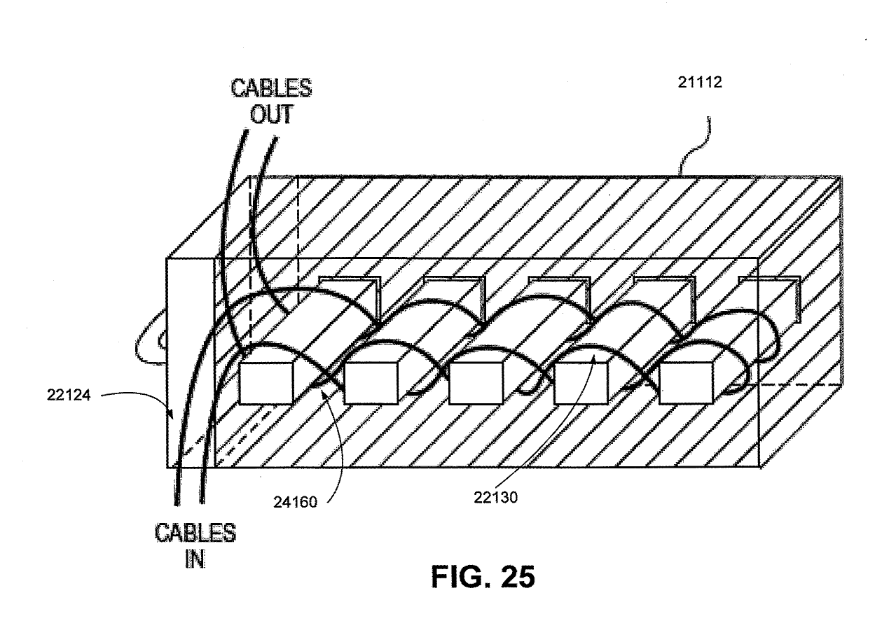

In an alternative example, rather than including the orifices 22140, a planar surface 22130′ may be provided with slots 24160 through which cable can be twined. FIGS. 24 and 25 illustrate examples in which the planar surface 22130′ includes slots 24160. FIG. 24 shows a top view of the cable drawer 21112 according to this example embodiment. FIG. 25 shows a side view of the cable drawer 21112 with transparent side members, to permit viewing of the contents of the cable drawer 21112 for ease of explanation. In some cases, the planar surface 22130′ may extend from one side member 22122 to the other, and the slots 24160 may also extend from one side member 22122 to the other, as shown in FIGS. 24 and 25. However, other arrangements are also possible, such as the slots 24160 only extending over a portion of the width of the planar surface 22130′. Furthermore, it should be appreciated that the horizontally extending members in FIGS. 24 and 25 could instead be extended vertically, could include any number of members, and could include members having any desirable shape (e.g., dowel shaped or otherwise having rounded edges).

Accordingly, embodiments of the present invention may provide for retractable cable drawers to be provided in cable ways to collect excess or slack cable. The cable drawers may include a planar surface through which the slack cable can be twined or wound, in order to take up the slack in an organized fashion. The planar surface may have openings therein that take the form of slots or orifices through which the cables may be wound. Furthermore, in some cases, the slack cable may be spooled through the openings multiple times, or not at all, dependent upon the amount of slack to be taken up. However, in an alternative example, one or more of the side member 22122, the front member 22120, and the back member 22124, may themselves include openings, to permit winding of the cable through the openings to take up cable slack.

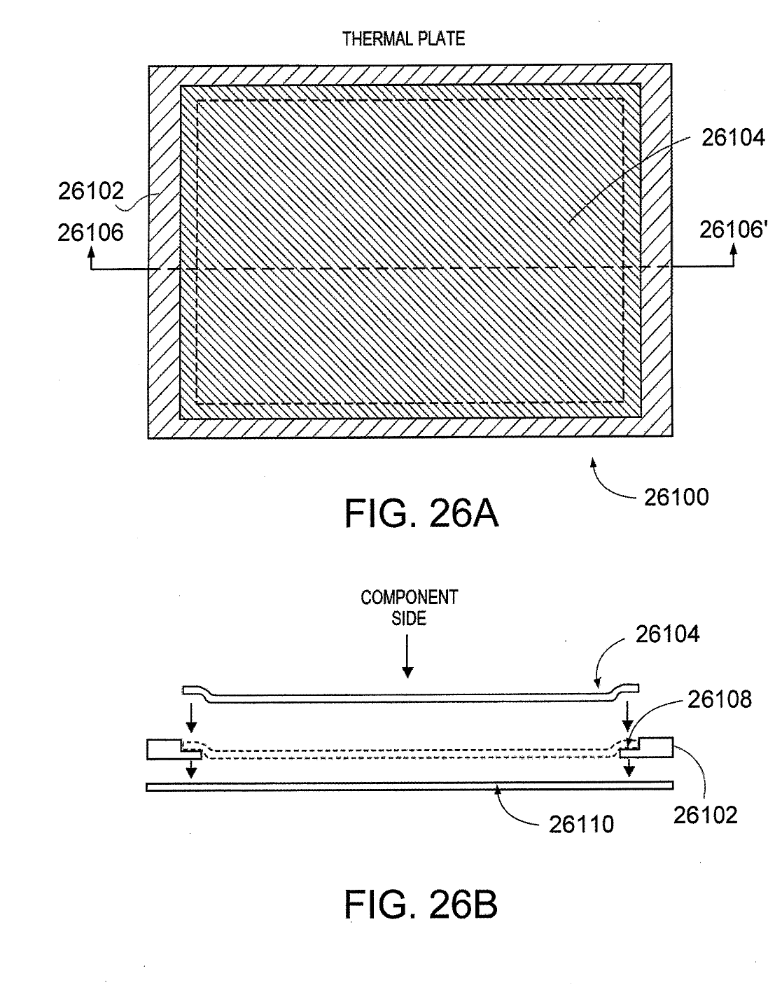

Additionally, to assist in handling thermal issues, in some embodiments, such as those shown in FIGS. 11 to 16, thermal plates (e.g., thermal plates 71 and 72 and thermal plates 87 and 88) may be unitary structures made from heat conducting materials (e.g., aluminum alloys, copper, etc.). However, in some alternative embodiments, thermal plates may incorporate multiple components. In this regard, for example, some embodiments may provide thermal plates that include a frame and a heat exchanger coupled to the frame. FIG. 26, which includes FIGS. 26A and 26B, shows an example of a thermal plate 26100 that includes a frame 26102 and a heat exchanger insert 26104.

FIG. 26A provides a top view of the thermal plate 26100. Meanwhile, FIG. 26B illustrates a cross section of the thermal plate 26100 taken along line 26106-26106′. The frame 26102 may be constructed to extend around the perimeter of the heat exchanger insert 26104 to provide a support platform 26108 to support edges of the heat exchanger insert 26104, while enabling a large portion of the surface area of the heat exchanger insert 26104 to come into contact with a cooling shelf 26110 of a cooling partition (e.g., cooling partition 59) to facilitate heat transfer. In some embodiments, although the frame 26102 may be rigidly constructed, the heat exchanger insert 26104 may be made from a flexible material such that the heat exchanger insert 26104 may be bowed outward with respect to an inner side of the thermal plate 26100, which may be proximate to components of a module fixture (e.g., components of a component unit including a component board upon which components are mounted). The heat exchanger insert 26104 may be any material or structure that is conducive to conducting heat in an efficient manner. Thus, for example, in some cases, the heat exchanger insert 26104 may be embodied as a flat heat pipe or other similar structure.

The bowing, which is illustrated in FIG. 26B, may provide a contact bias between an outer surface of the thermal plate 26100 and the cooling shelf 26110. The contact bias may enable a majority of the heat exchanger insert 26104 to be in contact with the cooling shelf 26110, to increase heat transfer away from components of the module fixture for removal via thermal coupling with the cooling shelf 26110. In some embodiments, a thermal conducting filler material may be placed between components of the module fixture and the heat exchanger insert 26104, to further facilitate heat transfer away from the components. Moreover, when either a component side or a non-component side of a component board of the component unit is proximate to the heat exchanger insert 26104, the heat exchanger insert 26104 may remove heat efficiently from the component unit.

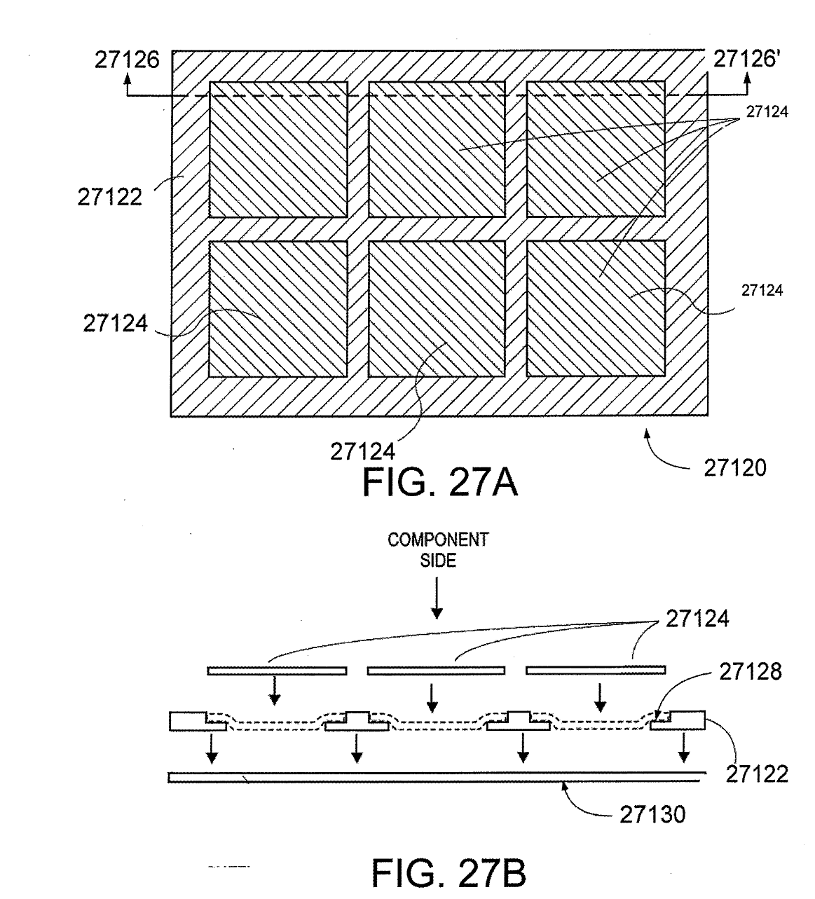

Although the thermal plate 26100 of FIG. 26 includes a single heat exchanger insert 26104, multiple heat exchanger inserts may be provided in alternative embodiments. FIG. 27, which includes FIGS. 27A and 27B, shows an example of a thermal plate 27120 having a frame 27122 including multiple insert receptacles for supporting a corresponding number of heat exchanger inserts 27124, to illustrate such an alternative embodiment. The multiple insert receptacles may substantially take the form of a window frame structure, where each of the “window panes” corresponds to a heat exchanger insert 27124. In this regard, FIG. 27A provides a top view of the thermal plate 27120. Meanwhile, FIG. 27B illustrates a cross section of the thermal plate 27120 taken along line 27126-27126′. The frame 27122 may be constructed such that the insert receptacles extend around the perimeter of each respective one of the heat exchanger inserts 27124, to provide a support platform 27128 to support edges of the heat exchanger inserts 27124, while enabling a large portion of the surface area of the heat exchanger inserts 27124 to come into contact with a cooling shelf 27130 of a cooling partition (e.g., cooling partition 59) to facilitate heat transfer.

Similarly, the frame 27122 may be rigidly constructed and the heat exchanger inserts 27124 may be made from a flexible material, such that the heat exchanger inserts 27124 may be bowed outward with respect to an inner side of the thermal plate 27120. The inner side of the thermal plate 27120 may be proximate to components of a module fixture and may be thermally coupled to these components via a thermal conducting filler, as described herein. However, in some embodiments, the components may be mounted to the frame 27122, and heat may be passed from the frame to the heat exchanger inserts 27124, such that the heat exchanger inserts 27124 act as a heat spreader to more efficiently dissipate heat away from the components.

As shown in FIG. 27B, the bowing of the heat exchanger inserts 27124 may provide a contact bias between an outer surface of the thermal plate 27120 and the cooling shelf 27130. The contact bias may enable a majority of the heat exchanger inserts 27124 to be in contact with the cooling shelf 27130, to increase heat transfer away from components of the module fixture for removal via thermal coupling with the cooling shelf 27130. Moreover, when either a component side or a non-component side of the component board of the component unit is proximate to the heat exchanger inserts 27124, the heat exchanger inserts 27124 may remove heat efficiently from the component unit.

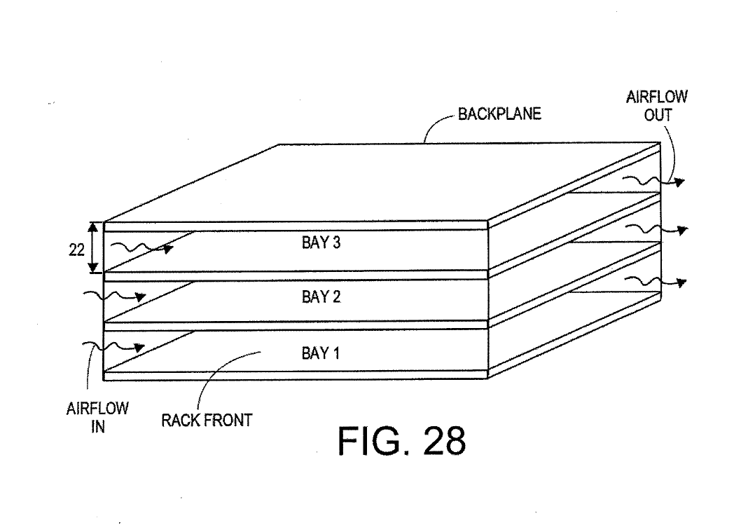

In an exemplary embodiment, the module fixture 89 of FIGS. 15 and 16 or the module fixture 70 of FIGS. 11 to 14 may be inserted into one of the bays (e.g., module bay 65) of FIG. 10. The tensioners (e.g., tensioners 84₁ and 84₂ of FIGS. 15 and 16 or tensioners 74₁ and 74₂ of FIGS. 11 to 14, respectively) may bias thermal plates associated with each respective module fixture outward, to enhance contact between the corresponding thermal plates and the corresponding sides of each cooled partition (e.g., cooled partition 59) of the bays. The cooling provided to the cooled partition 59 may be provided by virtue of passing coolant (e.g., a refrigerant, water, and/or the like) from the coolant inlet 49 to the coolant outlet 50. However, in an alternative embodiment, airflow may be allowed to pass (or forced) through the bays as is shown in FIG. 28.

In any case, some exemplary embodiments may provide for mechanisms to facilitate efficient heat removal from module fixtures in a rack system capable of supporting a plurality of data networking, processing, and/or storage components. Accordingly, a relatively large capacity for reliable computing may be provided and supported in a relatively small area, due to the ability to efficiently cool the heat dissipating components within the rack system.

As mentioned above, each of the service units or modules that may be housed in the rack system 10 may provide some combination of data networking, processing, and storage capacity, enabling the service units to provide functional support for various data related activities (e.g., as processing units, storage arrays, network switches, etc.). Some example embodiments of the present invention provide a mechanical structure for the rack system and the service units or modules that provides for efficient heat removal from the service units or modules in a compact design. Thus, the amount of data networking, processing, and storage capacity that can be provided for a given amount of cost may be increased, where elements of cost include manufacturing cost, lifecycle maintenance cost, amount of space occupied, and operational energy cost.

Some example embodiments of the present invention may enable networking of multiple rack systems 10 to provide a highly scalable modular architecture. In this regard, for example, a plurality of rack systems could be placed in proximity to one another to provide large capacity for processing and/or storing data within a relatively small area. Moreover, due to the efficient cooling design of the rack system 10, placing a plurality of rack systems in a small area may not require additional environmental cooling requirements beyond the cooling provided by each respective rack system 10. As such, massive amounts of data networking, processing, and storage capacity may be made available with a relatively low complexity architecture and a relatively low cost for maintenance and installation. The result may be that potentially very large cost and energy savings can be realized over the life of the rack systems, relative to conventional data systems. Thus, embodiments of the present invention may have a reduced environmental footprint relative to conventional data systems.

Another benefit of the efficient architecture of the rack system 10 described herein, which flows from the ability to interconnect multiple rack systems in a relatively small area, is that such interconnected multiple rack systems may be implemented on a mobile platform. Thus, for example, a plurality of rack systems may be placed in a mobile container such as an inter-modal shipping container. The mobile container may have a size and shape that is tailored to the specific mobile platform for which implementation is desired. Accordingly, it may be possible to provide very robust data networking, processing, and storage capabilities in a modular and mobile platform.

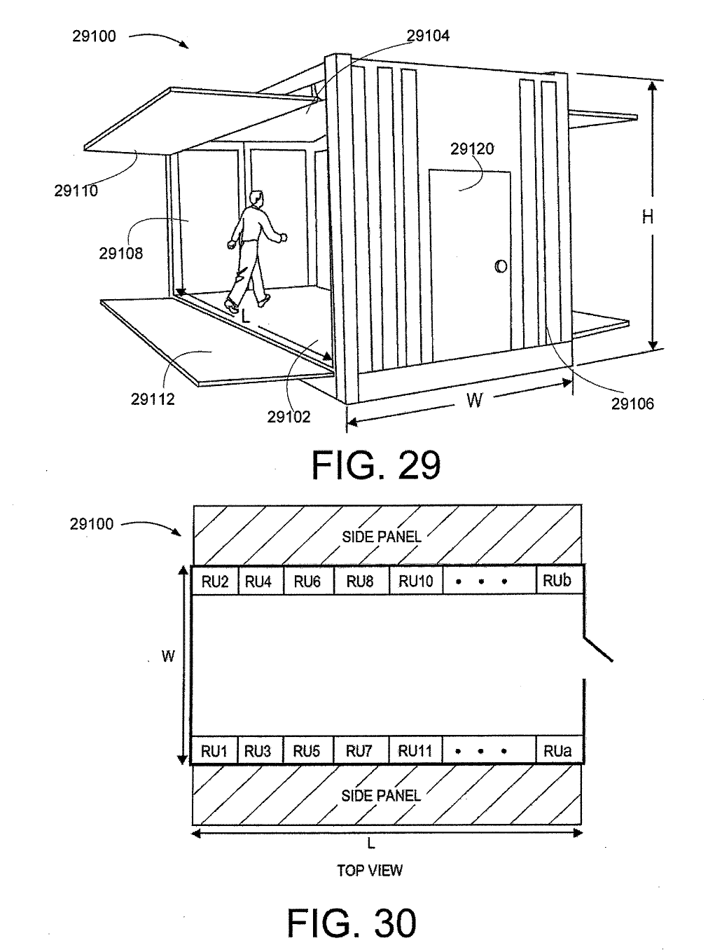

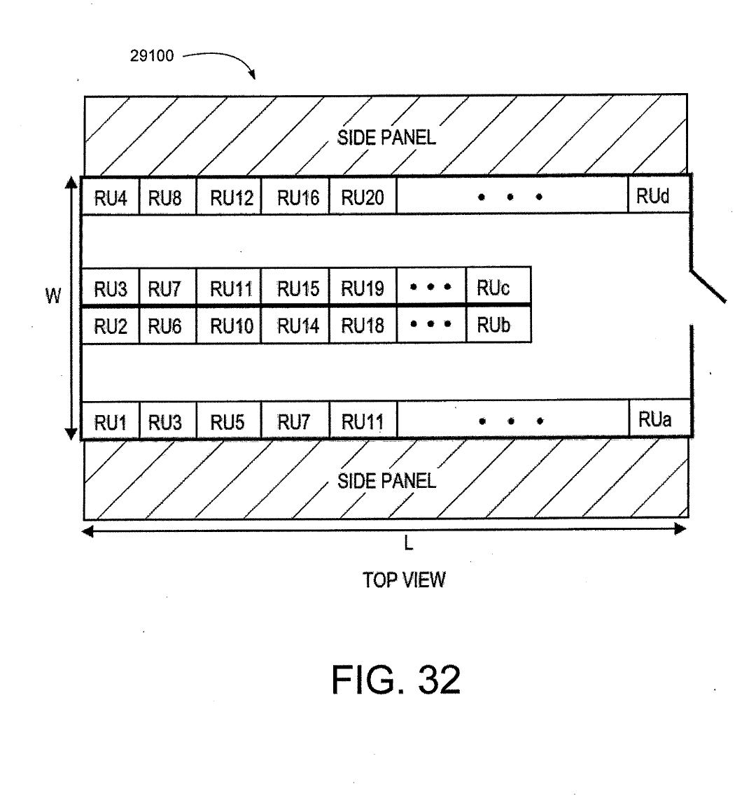

FIGS. 29 to 32 illustrate examples of a mobile container 29100 that may be implemented in connection with some exemplary embodiments. The mobile container 29100 may have dimensions including length (L), height (H) and width (W) that are selected based on the mobile platform upon which the mobile container 29100 is expected to be mounted for transportation. Thus, for example, dimensions of the mobile container 29100 may be selected so that the mobile container 29100 may fit within a cargo bay of a ship or aircraft, or fit on a flatbed rail car, automobile, or semi-trailer. In some situations, the number of rack systems that are needed or desired for a specific embodiment may be a determining factor in selecting a size for the mobile container 29100. As such, for example, the length of the mobile container 29100 may be selected to be a multiple of the width dimension of the rack system 10.

The mobile container 29100 may include side panels that may be removed or otherwise opened, to enable side access to the mobile container 29100 via the long dimension of the mobile container 29100. The provision of side access may facilitate onloading and offloading of the rack systems disposed in the mobile container 29100. In some embodiments, as shown in FIGS. 29 to 32, the mobile container 29100 may include a bottom element 29102, a top element 29104, a front element 29106, a back element 29108, and two side elements or side panels. In some embodiments, the side panels may have a length longer than the front element and the back element. Moreover, in some cases, at least one of the side panels or the front/back elements may include one or more access panels to permit access to the mobile container 29100. In an exemplary embodiment, the side panels may include a side panel top 29110 and a side panel bottom 29112 that fold up and down, respectively, to enable access to the mobile container. However, in alternative embodiments, side panels may slide horizontally or swing open in opposite directions rotating about a vertical axis, instead of rotating about a horizontal axis like the side panel top 29110 and the side panel bottom 29112 of FIGS. 29 to 32. In still other alternative embodiments, the side panels may include a single panel that swings open about a horizontal or vertical axis, or that is completely removable when unlatched.

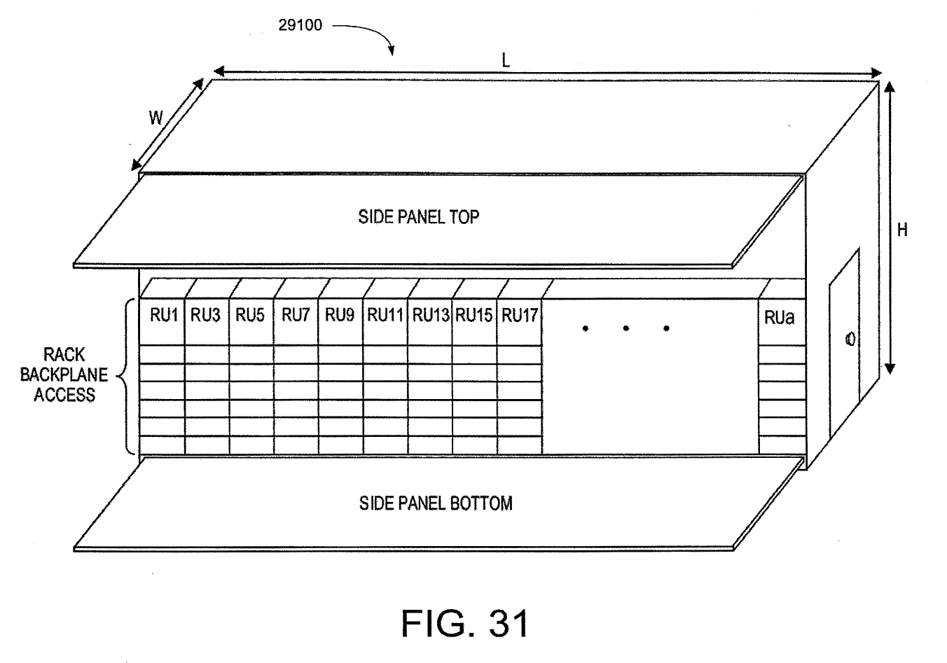

As shown in FIGS. 30 and 31, a plurality of rack systems (e.g., RU1 to RUb) may be moved into the mobile container 29100 via the side access provided by the side panels. Moreover, the rack systems may be positioned such that backplane access is achievable via opened side panels as shown in FIG. 31. Thus, the rack front 18 of each rack system 10 may be accessible from the interior of the mobile container 29100 after the mobile container 29100 has been loaded fully with rack systems. In other words, the rack systems may be positioned in a side-by-side fashion along the interior perimeter of the length dimension of the mobile container 29100, such that the rack fronts of all of the rack systems on one side of the mobile container 29100 are in alignment with each other, and all of the rack fronts of all of the rack systems on the other side of the mobile container 29100 are in alignment with each other as well.

In any case, in some exemplary embodiments, rather than using a refrigerant or a liquid coolant to provide cooling to the rack systems, the cooling distribution system may be coupled to an airflow source. The airflow source may then be configured to provide airflow through the plurality of bays of each rack frame, to cool the service units or modules therein.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1-120. (canceled)

121. A rack system comprising:
one or more recirculation pumps integrated into the rack system, the one or more recirculation pumps being configured to force a refrigerant through a cooling circuit of the rack system;
a plurality of bays configured to receive a respective module in each bay, the modules being configured to perform at least one of data networking, data processing, or data storage;
a respective coolant partition disposed between each of the bays in the plurality of bays, each respective coolant partition being included in the cooling circuit of the rack system; and
one or more heat rejection units configured to dissipate heat from the refrigerant that has been circulated through cooling circuit of the rack system.

122. The rack system of claim 121 further comprising a vapor condenser area, the vapor condenser area being configured to:
receive a vapor or mixed vapor/liquid form of the refrigerant from outlet manifolds of each of the coolant partitions,
condense the vapor form of the refrigerant into a liquid form of the refrigerant, and
drain the liquid form of the refrigerant to at least one of the one or more recirculation pumps.

123. The rack system of claim 121 wherein at least one of the one or more heat rejection units is a refrigerant-to-water heat exchanger.

124. The rack system of claim 121 wherein at least one of the one or more heat rejection units is a refrigerant-to-air heat exchanger.

125. A rack system comprising:
one or more recirculation pumps, the one or more recirculation pumps being configured to force a refrigerant through a plurality of cooling circuits of the rack system, the plurality of cooling circuits including a first cooling circuit and a redundant cooling circuit;
a plurality of bays configured to receive a respective module in each bay, the modules being configured to perform at least one of data networking, data processing, or data storage; and
a respective coolant partition disposed between each of the bays in the plurality of bays, each respective coolant partition including a plurality of strips, the plurality of strips including a first strip that is part of the first cooling circuit and a second strip that is part of the redundant cooling circuit.

126. The rack system of claim 125 wherein the plurality of cooling circuits are configured to permit a continuous flow of refrigerant through the redundant cooling circuit in an instance in which the first cooling circuit is disabled, and permit a continuous flow of refrigerant through the first cooling circuit in an instance in which the redundant cooling circuit is disabled.

127. A rack system comprising:
a module insertion area on a first side of a rack frame;
a universal backplane area including at least one mounting surface configured to mount at least one service unit backplane board, wherein each service unit backplane board is configured to couple to one or more respective service unit component modules each being configured to perform at least one of data networking, data processing, or data storage; and
one or more service units that each include one or more service unit backplanes and one or more service unit component modules configured to connect through one or more bays to the backplane of the rack frame; and
a power bus configured to provide power to one or more service unit backplane boards mounted in the universal backplane area.

128. The rack system of claim 127, wherein a first service unit of the one or more service units is a cluster unit including a central module configured to perform at least one of data networking, data processing, or data storage.

129. The rack system of claim 128, wherein the cluster unit further includes at least a second module configured to perform at least one of data processing or data storage.

130. The rack system of claim 128, wherein the cluster unit further includes at least a second module dedicated to data processing or data storage.
